(19) United States
(12) Patent Application Publication
(10) Pub. No.: US 2025/0056512 A1
(43) Pub. Date: Feb. 13, 2025

(54) FREQUENCY ADJUSTMENT FOR SUB-BAND FULL DUPLEX CONFLICT HANDLING

(71) Applicant: QUALCOMM Incorporated, San Diego, CA (US)

(72) Inventors: Qian ZHANG, Basking Ridge, NJ (US); Junyi LI, Fairless Hills, PA (US); Yan ZHOU, San Diego, CA (US)

(21) Appl. No.: 18/446,846

(22) Filed: Aug. 9, 2023

(51) Int. Cl. H04W 72/0453; H04L 5/14; H04W 72/11

(52) U.S. Cl. CPC H04W 72/0453; H04L 5/14; H04W 72/11

(57) ABSTRACT

Methods, systems, and devices for wireless communications are described. Generally, a user equipment (UE) may perform an adjustment procedure for one or more frequency resources of an uplink message or a downlink message to avoid collisions within a sub-band full duplex (SBFD) slot. In some cases, the UE may identify that a resource allocation for the downlink message extends over at least a portion of a resource allocation for the uplink message (or a guard band for the uplink message), and may perform the adjustment procedure for the uplink resource allocation. The adjustment procedure may include only using resources of the uplink resource allocation that do not overlap resources of the downlink resource allocation, shifting the uplink resource allocation within an uplink sub-band, or both. Additionally, or alternatively, such techniques may be extended to adjust the downlink resource allocation, for example, based on a type of the downlink message.

### FIELD OF TECHNOLOGY

The following relates to wireless communications, including frequency adjustment for sub-band full duplex (SBFD) conflict handling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support frequency adjustment for sub-band full duplex (SBFD) conflict handling. For example, the described techniques enable a user equipment (UE) to perform an adjustment procedure for one or more frequency resources of an uplink message or a downlink message to avoid collisions within a SBFD slot (e.g., a slot, mini-slot, symbol, or other time period that includes uplink sub-bands and downlink sub-bands or frequency resource allocations for multiple communication directions). In some cases, the UE may identify that a resource allocation for the downlink message extends over at least a portion of a resource allocation for the uplink message (or a guard band for the uplink message), and may perform the adjustment procedure for the uplink resource allocation. The adjustment procedure may include only using resources of the uplink resource allocation that do not overlap resources of the downlink resource allocation, shifting the uplink resource allocation within an uplink sub-band, or both. Such techniques may be extended to adjust the downlink resource allocation, for example, based on a type of the downlink message (e.g., whether the downlink message is a synchronization signal block (SSB)).

A method for wireless communications by a UE is described. The method may include receiving a first indication of one or more first frequency resources associated with a SSB, the one or more first frequency resources allocated within a SBFD slot, receiving a second indication of one or more second frequency resources associated with an uplink message for transmission by the UE, where the one or more second frequency resources are allocated within the SBFD slot and at least partially overlap the one or more first frequency resources in a frequency domain, performing, based on the one or more second frequency resources at least partially overlapping with the one or more first frequency resources in the frequency domain, an adjustment procedure for the one or more second frequency resources to obtain one or more third frequency resources for transmission of the uplink message by the UE, where the one or more third frequency resources are within the SBFD slot and are separate from the one or more first frequency resources in the frequency domain, and transmitting, in accordance with the adjustment procedure, the uplink message via the one or more third frequency resources during the SBFD slot.

A UE for wireless communications is described. The UE may include one or more memories storing processor executable code, and one or more processors coupled with the one or more memories. The one or more processors may individually or collectively operable to execute the code to cause the UE to receive a first indication of one or more first frequency resources associated with a SSB, the one or more first frequency resources allocated within a SBFD slot, receive a second indication of one or more second frequency resources associated with an uplink message for transmission by the UE, where the one or more second frequency resources are allocated within the SBFD slot and at least partially overlap the one or more first frequency resources in a frequency domain, perform, based on the one or more second frequency resources at least partially overlapping with the one or more first frequency resources in the frequency domain, an adjustment procedure for the one or more second frequency resources to obtain one or more third frequency resources for transmission of the uplink message by the UE, where the one or more third frequency resources are within the SBFD slot and are separate from the one or more first frequency resources in the frequency domain, and transmit, in accordance with the adjustment procedure, the uplink message via the one or more third frequency resources during the SBFD slot.

Another UE for wireless communications is described. The UE may include means for receiving a first indication of one or more first frequency resources associated with a SSB, the one or more first frequency resources allocated within a SBFD slot, means for receiving a second indication of one or more second frequency resources associated with an uplink message for transmission by the UE, where the one or more second frequency resources are allocated within the SBFD slot and at least partially overlap the one or more first frequency resources in a frequency domain, means for performing, based on the one or more second frequency resources at least partially overlapping with the one or more first frequency resources in the frequency domain, an adjustment procedure for the one or more second frequency resources to obtain one or more third frequency resources for transmission of the uplink message by the UE, where the one or more third frequency resources are within the SBFD slot and are separate from the one or more first frequency resources in the frequency domain, and means for transmitting, in accordance with the adjustment procedure, the uplink message via the one or more third frequency resources during the SBFD slot.

A non-transitory computer-readable medium storing code for wireless communications is described. The code may include instructions executable by a processor to receive a first indication of one or more first frequency resources associated with a SSB, the one or more first frequency resources allocated within a SBFD slot, receive a second indication of one or more second frequency resources associated with an uplink message for transmission by the UE, where the one or more second frequency resources are allocated within the SBFD slot and at least partially overlap the one or more first frequency resources in a frequency domain, perform, based on the one or more second frequency resources at least partially overlapping with the one or more first frequency resources in the frequency domain, an adjustment procedure for the one or more second frequency resources to obtain one or more third frequency resources for transmission of the uplink message by the UE, where the one or more third frequency resources are within the SBFD slot and are separate from the one or more first frequency resources in the frequency domain, and transmit, in accordance with the adjustment procedure, the uplink message via the one or more third frequency resources during the SBFD slot.

In some examples of the method, UEs, and non-transitory computer-readable medium described herein, the one or more second frequency resources and the one or more third frequency resources may be allocated within an uplink sub-band of the SBFD slot; and the one or more first frequency resources may be allocated at least partially within the uplink sub-band or at least partially within a guard band between the uplink sub-band and a downlink sub-band of the SBFD slot.

In some examples of the method, UEs, and non-transitory computer-readable medium described herein, performing the adjustment procedure may include operations, features, means, or instructions for selecting the one or more third frequency resources from the one or more second frequency resources, where a resource separation between the one or more third frequency resources and the one or more first frequency resources in the frequency domain satisfies a threshold quantity of resource blocks (RBs) corresponding to a size of the guard band.

In some examples of the method, UEs, and non-transitory computer-readable medium described herein, selecting the one or more third frequency resources may include operations, features, means, or instructions for selecting the one or more third frequency resources from a portion of the one or more second frequency resources that does not overlap the one or more first frequency resources.

In some examples of the method, UEs, and non-transitory computer-readable medium described herein, transmitting the uplink message may include operations, features, means, or instructions for applying uplink rate matching to the one or more third resources based on selecting the one or more third resources and transmitting the uplink message in accordance with a data rate that may be based on applying the uplink rate matching.

In some examples of the method, UEs, and non-transitory computer-readable medium described herein, performing the frequency adjustment procedure may include operations, features, means, or instructions for shifting, within the uplink sub-band, the one or more second frequency resources to obtain the one or more third frequency resources, where the one or more second frequency resources and the one or more third frequency resources include a same quantity of RBs.

Some examples of the method, UEs, and non-transitory computer-readable medium described herein may further include operations, features, means, or instructions for transmitting a capability report indicating a capability of the UE to perform uplink rate matching.

Some examples of the method, UEs, and non-transitory computer-readable medium described herein may further include operations, features, means, or instructions for selecting a type of the adjustment procedure from a set of multiple types of adjustment procedures in accordance with one or more rules that may be based on the one or more second frequency resources at least partially overlapping the one or more first frequency resources in the frequency domain.

Some examples of the method, UEs, and non-transitory computer-readable medium described herein may further include operations, features, means, or instructions for receiving a control message indicating a type of the adjustment procedure, where the adjustment procedure may be performed in accordance with the type.

Some examples of the method, UEs, and non-transitory computer-readable medium described herein may further include operations, features, means, or instructions for receiving a control signal that dynamically schedules the uplink message or activates the uplink message for semi-persistent scheduling, where the control signal may be specific to the UE, associated with a group of UEs including the UE, or broadcast to each UE of a cell including the UE.

A method for wireless communications by a UE is described. The method may include receiving, from a network entity, a first control message indicating one or more first frequency resources associated with a first signal having a first communication direction between the UE and the network entity, the one or more first frequency resource allocated within a SBFD slot, receiving, from the network entity, a second control message indicating one or more second frequency resources associated with a second signal having a second communication direction between the UE and the network entity that is different from the first communication direction, where the one or more second frequency resources are allocated within the SBFD slot and at least partially overlap the one or more first frequency resources in a frequency domain, performing, based on the one or more second frequency resources at least partially overlapping the one or more first frequency resources in the frequency domain, an adjustment procedure for the one or more first frequency resources to obtain one or more third frequency resources for communication of the first signal, and communicating, in accordance with the adjustment procedure, the first signal via the one or more third frequency resources, the second signal via the one or more second frequency resources, or both, during the SBFD slot.

A UE for wireless communications is described. The UE may include one or more memories storing processor executable code, and one or more processors coupled with the one or more memories. The one or more processors may individually or collectively operable to execute the code to cause the UE to receive, from a network entity, a first control message indicating one or more first frequency resources associated with a first signal having a first communication direction between the UE and the network entity, the one or more first frequency resource allocated within a SBFD slot, receive, from the network entity, a second control message indicating one or more second frequency resources associated with a second signal having a second communication direction between the UE and the network entity that is different from the first communication direction, where the one or more second frequency resources are allocated within the SBFD slot and at least partially overlap the one or more first frequency resources in a frequency domain, perform, based on the one or more second frequency resources at least partially overlapping the one or more first frequency resources in the frequency domain, an adjustment procedure for the one or more first frequency resources to obtain one or more third frequency resources for communication of the first signal, and communicating, in accordance with the adjustment procedure, the first signal via the one or more third frequency resources, the second signal via the one or more second frequency resources, or both, during the SBFD slot.

Another UE for wireless communications is described. The UE may include means for receiving, from a network entity, a first control message indicating one or more first frequency resources associated with a first signal having a first communication direction between the UE and the network entity, the one or more first frequency resource allocated within a SBFD slot, means for receiving, from the network entity, a second control message indicating one or more second frequency resources associated with a second signal having a second communication direction between the UE and the network entity that is different from the first communication direction, where the one or more second frequency resources are allocated within the SBFD slot and at least partially overlap the one or more first frequency resources in a frequency domain, means for performing, based on the one or more second frequency resources at least partially overlapping the one or more first frequency resources in the frequency domain, an adjustment procedure for the one or more first frequency resources to obtain one or more third frequency resources for communication of the first signal, and means for communicating, in accordance with the adjustment procedure, the first signal via the one or more third frequency resources, the second signal via the one or more second frequency resources, or both, during the SBFD slot.

A non-transitory computer-readable medium storing code for wireless communications is described. The code may include instructions executable by a processor to receive, from a network entity, a first control message indicating one or more first frequency resources associated with a first signal having a first communication direction between the UE and the network entity, the one or more first frequency resource allocated within a SBFD slot, receive, from the network entity, a second control message indicating one or more second frequency resources associated with a second signal having a second communication direction between the UE and the network entity that is different from the first communication direction, where the one or more second frequency resources are allocated within the SBFD slot and at least partially overlap the one or more first frequency resources in a frequency domain, perform, based on the one or more second frequency resources at least partially overlapping the one or more first frequency resources in the frequency domain, an adjustment procedure for the one or more first frequency resources to obtain one or more third frequency resources for communication of the first signal, and communicating, in accordance with the adjustment procedure, the first signal via the one or more third frequency resources, the second signal via the one or more second frequency resources, or both, during the SBFD slot.

In some examples of the method, UEs, and non-transitory computer-readable medium described herein, the one or more first frequency resources and the one or more third frequency resources may be allocated within a first sub-band of the SBFD slot configured for the first communication direction; and the one or more second frequency resources may be allocated at least partially within the first sub-band or at least partially within a guard band between the first sub-band and a second sub-band of the SBFD slot configured for the second communication direction.

In some examples of the method, UEs, and non-transitory computer-readable medium described herein, performing the adjustment procedure may include operations, features, means, or instructions for selecting the one or more third frequency resources from the one or more first frequency resources, where a resource separation between the one or more third frequency resources and the one or more second frequency resources in the frequency domain satisfies a threshold quantity of RBs corresponding to a size of the guard band.

In some examples of the method, UEs, and non-transitory computer-readable medium described herein, selecting the one or more third frequency resource may include operations, features, means, or instructions for selecting the one or more third frequency resource from a portion of the one or more first frequency resources that does not overlap the one or more second frequency resources.

In some examples of the method, UEs, and non-transitory computer-readable medium described herein, communicating the first signal may include operations, features, means, or instructions for applying the rate matching to the one or more third resources based on selecting the one or more third resources and communicating the first signal in accordance with a data rate that may be based on applying the rate matching.

In some examples of the method, UEs, and non-transitory computer-readable medium described herein, performing the adjustment procedure may include operations, features, means, or instructions for shifting, within the first sub-band, the one or more first frequency resources to obtain the one or more third frequency resources, where the one or more first frequency resources and the one or more third frequency resources include a same quantity of RBs.

In some examples of the method, UEs, and non-transitory computer-readable medium described herein, the one or more second frequency resources may be allocated within a first sub-band of the SBFD slot configured for the second communication direction; and the one or more first frequency resources may be allocated at least partially within the first sub-band, where performing the adjustment procedure may be based on the one or more first frequency resource being allocated at least partially within the first sub-band.

Some examples of the method, UEs, and non-transitory computer-readable medium described herein may further include operations, features, means, or instructions for selecting a type of the adjustment procedure from a set of multiple types of adjustment procedures in accordance with one or more rules that may be based on the one or more second frequency resources at least partially overlapping the one or more first frequency resources in the frequency domain.

Some examples of the method, UEs, and non-transitory computer-readable medium described herein may further include operations, features, means, or instructions for receiving a third control message indicating a type of the adjustment procedure, where the adjustment procedure may be performed in accordance with the type.

Some examples of the method, UEs, and non-transitory computer-readable medium described herein may further include operations, features, means, or instructions for receiving a third control message that dynamically schedules the first signal or activates the first signal for semi-persistent scheduling, where the third control message may be specific to the UE, associated with a group of UEs including the UE, or broadcast to each UE of a cell including the UE.

In some examples of the method, UEs, and non-transitory computer-readable medium described herein, the first signal may be dynamically scheduled and the second signal may be periodically scheduled or semi-persistently scheduled; the first signal may be periodically scheduled or semi-persistently scheduled and the second signal may be dynamically scheduled; or the first signal may be periodically scheduled or semi-persistently scheduled and the second signal may be periodically scheduled or semi-persistently scheduled.

A method for wireless communications by a network entity is described. The method may include transmitting, to a UE, a first control message indicating one or more first frequency resources associated with a first signal having a first communication direction between the network entity and the UE, the one or more first frequency resource allocated within a SBFD slot, transmitting, to the UE, a second control message indicating one or more second frequency resources associated with a second signal having a second communication direction between the network entity and the UE that is different from the first communication direction, where the one or more second frequency resources are allocated within the SBFD slot and at least partially overlap the one or more first frequency resources in a frequency domain, and communicating, with the UE, the first signal via one or more third frequency resources, the second signal via the one or more second frequency resources, or both, during the SBFD slot, where the one or more third frequency resources are based on an adjustment procedure for the one or more first frequency resources, and where the adjustment procedure is based on the one or more second frequency resources at least partially overlapping the one or more first frequency resources in the frequency domain.

A network entity for wireless communications is described. The network entity may include one or more memories storing processor executable code, and one or more processors coupled with the one or more memories. The one or more processors may individually or collectively operable to execute the code to cause the network entity to transmit, to a UE, a first control message indicating one or more first frequency resources associated with a first signal having a first communication direction between the network entity and the UE, the one or more first frequency resource allocated within a SBFD slot, transmit, to the UE, a second control message indicating one or more second frequency resources associated with a second signal having a second communication direction between the network entity and the UE that is different from the first communication direction, where the one or more second frequency resources are allocated within the SBFD slot and at least partially overlap the one or more first frequency resources in a frequency domain, and communicating, with the UE, the first signal via one or more third frequency resources, the second signal via the one or more second frequency resources, or both, during the SBFD slot, where the one or more third frequency resources be based on an adjustment procedure for the one or more first frequency resources, and where the adjustment procedure is based on the one or more second frequency resources at least partially overlapping the one or more first frequency resources in the frequency domain.

Another network entity for wireless communications is described. The network entity may include means for transmitting, to a UE, a first control message indicating one or more first frequency resources associated with a first signal having a first communication direction between the network entity and the UE, the one or more first frequency resource allocated within a SBFD slot, means for transmitting, to the UE, a second control message indicating one or more second frequency resources associated with a second signal having a second communication direction between the network entity and the UE that is different from the first communication direction, where the one or more second frequency resources are allocated within the SBFD slot and at least partially overlap the one or more first frequency resources in a frequency domain, and means for communicating, with the UE, the first signal via one or more third frequency resources, the second signal via the one or more second frequency resources, or both, during the SBFD slot, where the one or more third frequency resources are based on an adjustment procedure for the one or more first frequency resources, and where the adjustment procedure is based on the one or more second frequency resources at least partially overlapping the one or more first frequency resources in the frequency domain.

A non-transitory computer-readable medium storing code for wireless communications is described. The code may include instructions executable by a processor to transmit, to a UE, a first control message indicating one or more first frequency resources associated with a first signal having a first communication direction between the network entity and the UE, the one or more first frequency resource allocated within a SBFD slot, transmit, to the UE, a second control message indicating one or more second frequency resources associated with a second signal having a second communication direction between the network entity and the UE that is different from the first communication direction, where the one or more second frequency resources are allocated within the SBFD slot and at least partially overlap the one or more first frequency resources in a frequency domain, and communicating, with the UE, the first signal via one or more third frequency resources, the second signal via the one or more second frequency resources, or both, during the SBFD slot, where the one or more third frequency resources be based on an adjustment procedure for the one or more first frequency resources, and where the adjustment procedure is based on the one or more second frequency resources at least partially overlapping the one or more first frequency resources in the frequency domain.

In some examples of the method, network entities, and non-transitory computer-readable medium described herein, the one or more first frequency resources and the one or more third frequency resources may be allocated within a first sub-band of the SBFD slot configured for the first communication direction; and the one or more second frequency resources may be allocated at least partially within the first sub-band or at least partially within a guard band between the first sub-band and a second sub-band of the SBFD slot configured for the second communication direction.

In some examples of the method, network entities, and non-transitory computer-readable medium described herein, the one or more third frequency resources may be selected from the one or more first frequency resources and a resource separation between the one or more third frequency resources and the one or more second frequency resources in the frequency domain satisfies a threshold quantity of RBs corresponding to a size of the guard band.

In some examples of the method, network entities, and non-transitory computer-readable medium described herein, the one or more first frequency resources may be shifted within the first sub-band to obtain the one or more third frequency resources and the one or more first frequency resources and the one or more third frequency resources include a same quantity of RBs.

In some examples of the method, network entities, and non-transitory computer-readable medium described herein, the one or more second frequency resources may be allocated within a first sub-band of the SBFD slot configured for the second communication direction; and the one or more first frequency resources may be allocated at least partially within the first sub-band.

Some examples of the method, network entities, and non-transitory computer-readable medium described herein may further include operations, features, means, or instructions for transmitting, to the UE, a third control message indicating a type of adjustment procedure for the one or more first frequency resources, where communicating the first signal via the one or more third frequency resources may be based on transmitting the third control message.

Some examples of the method, network entities, and non-transitory computer-readable medium described herein may further include operations, features, means, or instructions for transmitting a control message that dynamically schedules the first signal or activates the first signal for semi-persistent scheduling, where the third control message may be specific to the UE, associated with a group of UEs including the UE, or broadcast to each UE of a cell including the UE.

### BRIEF DESCRIPTION OF THE DRAWINGS

FIG. 1 shows an example of a wireless communications system that supports frequency adjustment for sub-band full duplex (SBFD) conflict handling in accordance with one or more aspects of the present disclosure.

FIG. 2 shows an example of a wireless communications system that supports frequency adjustment for SBFD conflict handling in accordance with one or more aspects of the present disclosure.

FIG. 3 shows an example of a resource diagram that supports frequency adjustment for SBFD conflict handling in accordance with one or more aspects of the present disclosure.

FIG. 4 shows an example of a resource diagram that supports frequency adjustment for SBFD conflict handling in accordance with one or more aspects of the present disclosure.

FIG. 5 shows an example of a resource diagram that supports frequency adjustment for SBFD conflict handling in accordance with one or more aspects of the present disclosure.

FIG. 6 shows an example of a resource diagram that supports frequency adjustment for SBFD conflict handling in accordance with one or more aspects of the present disclosure.

FIG. 7 shows an example of a resource diagram that supports frequency adjustment for SBFD conflict handling in accordance with one or more aspects of the present disclosure.

FIG. 8 shows an example of a process flow that supports frequency adjustment for SBFD conflict handling in accordance with one or more aspects of the present disclosure.

FIGS. 9 and 10 show block diagrams of devices that support frequency adjustment for SBFD conflict handling in accordance with one or more aspects of the present disclosure.

FIG. 11 shows a block diagram of a communications manager that supports frequency adjustment for SBFD conflict handling in accordance with one or more aspects of the present disclosure.

FIG. 12 shows a diagram of a system including a device that supports frequency adjustment for SBFD conflict handling in accordance with one or more aspects of the present disclosure.

FIGS. 13 and 14 show block diagrams of devices that support frequency adjustment for SBFD conflict handling in accordance with one or more aspects of the present disclosure.

FIG. 15 shows a block diagram of a communications manager that supports frequency adjustment for SBFD conflict handling in accordance with one or more aspects of the present disclosure.

FIG. 16 shows a diagram of a system including a device that supports frequency adjustment for SBFD conflict handling in accordance with one or more aspects of the present disclosure.

FIGS. 17 through 19 show flowcharts illustrating methods that support frequency adjustment for SBFD conflict handling in accordance with one or more aspects of the present disclosure.

### DETAILED DESCRIPTION

In some wireless communications systems, some slots (e.g., units of time domain resources) may be configured to support sub-band full duplex (SBFD) communications. For example, a bandwidth associated with an SBFD slot may support multiple sub-bands of different communication directions, such as one or more downlink sub-bands and one or more uplink sub-bands (e.g., enabling devices to communicate in both communication directions simultaneously within the SBFD slot). An SBFD slot may be support enhancements to latency, coverage, system capacity, spectrum efficiency, and system flexibility, among other advantages.

In some cases, a user equipment (UE) may be an example of a SBFD-aware UE, which may indicate that the UE is capable of communicating during the SBFD slot despite capability limitations of the UE (e.g., if the UE is configured for half-duplex communications). For example, an uplink message may be scheduled for transmission by the UE via an uplink sub-band of the SBFD slot at a same symbol as a downlink message is communicated via a downlink sub-band of the SBFD slot. However, some such downlink messages may at least partially overlap resources (e.g., resource blocks (RBs)) allocated to the uplink sub-band (or a guard band for the uplink sub-band), which may interfere with transmission of the uplink message by the UE, other UEs receiving the downlink message, or both.

To reduce or otherwise mitigate interference due to a resource collision at a same symbol(s) within a SBFD slot, a UE may perform an adjustment procedure to modify a resource allocation for an uplink message or a downlink message. In some cases, the UE may adjust an uplink resource allocation (e.g., for a dynamically scheduled or semi-persistent uplink message) when a downlink resource allocation (e.g., for a periodic synchronization signal block (SSB)) overlaps the uplink resource allocation at the same symbol of the SBFD. For example, if the downlink resource allocation extends over a portion of the uplink resource allocation, the UE may adjust the uplink resource allocation to instead use a remaining portion of the original uplink allocation (e.g., using resources that do not overlap the downlink resource allocation) for transmission of an uplink message. Additionally, or alternatively, the UE may shift the uplink resource allocation within the uplink sub-band (e.g., if enough resources are available within the uplink sub-band) to avoid collision with downlink resources. Similarly, the UE may perform such resource adjustment for the downlink resource allocation (e.g., adjusting resources monitored for downlink messages) to avoid collision with an uplink message. Such techniques may mitigate or reduce interference for UEs communicating using SBFD slots, thereby improving network efficiency and the use SBFD communications.

Aspects of the disclosure are initially described in the context of wireless communications systems. Aspects of the disclosure are further illustrated by and described in the context of resource diagrams and a process flow. Aspects of the disclosure are further illustrated by and described with reference to apparatus diagrams, system diagrams, and flowcharts that relate to frequency adjustment for SBFD conflict handling.

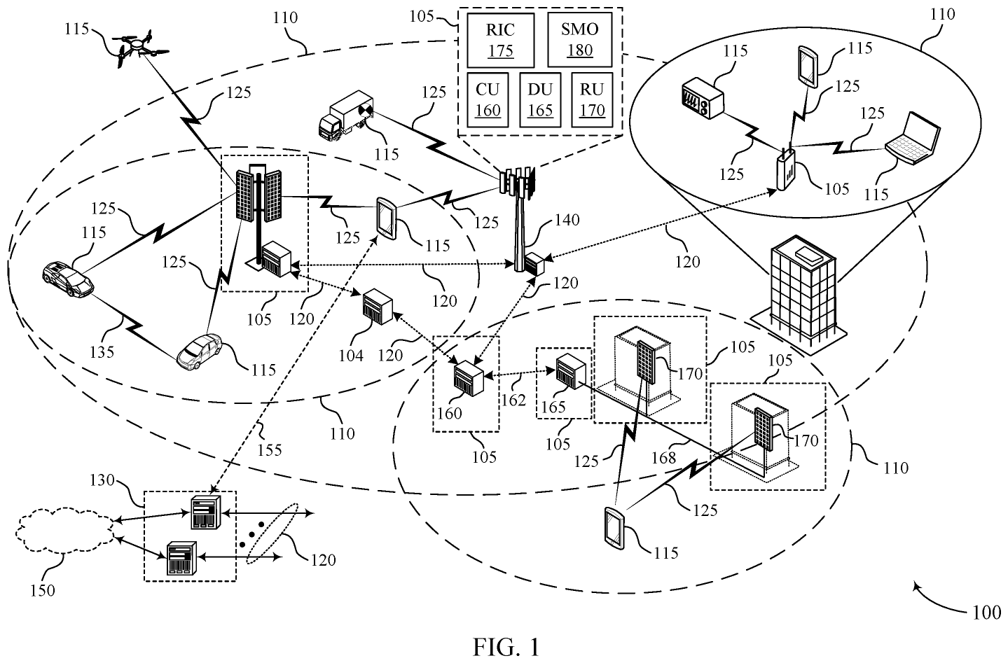

FIG. 1 shows an example of a wireless communications system 100 that supports frequency adjustment for SBFD conflict handling in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support frequency adjustment for SBFD conflict handling as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or RBs) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of the wireless communications system 100, a UE 115 may communicate during an SBFD slot, which may refer to any duration of time (e.g., slot, mini-slot, symbol, etc. having uplink and downlink sub-bands or uplink and downlink resources allocations). For example, the UE 115 may an SBFD-aware UE, which may indicate the UE 115 is capable of communicating during the SBFD slot despite capability limitations of the UE 115 (e.g., if the UE 115 is a half-duplex UE). In some cases, to avoid collisions between uplink messages and downlink messages within the SBFD slot, the UE 115 may perform an adjustment procedure for one or more frequency resources of an uplink message or a downlink message. For instance, the UE 115 may identify that a resource allocation for the downlink message extends over at least a portion of a resource allocation for the uplink message (or a guard band for the uplink message), and may perform the adjustment procedure for the uplink resource allocation. The adjustment procedure may include only using resources of the uplink resource allocation that do not overlap resources of the downlink resource allocation, shifting the uplink resource allocation within an uplink sub-band, or both. Such techniques may be extended to adjust the downlink resource allocation, for example, based on a type of the downlink message (e.g., whether the downlink message is a SSB). By performing the adjustment procedure, communications during the SBFD slot may be improved.

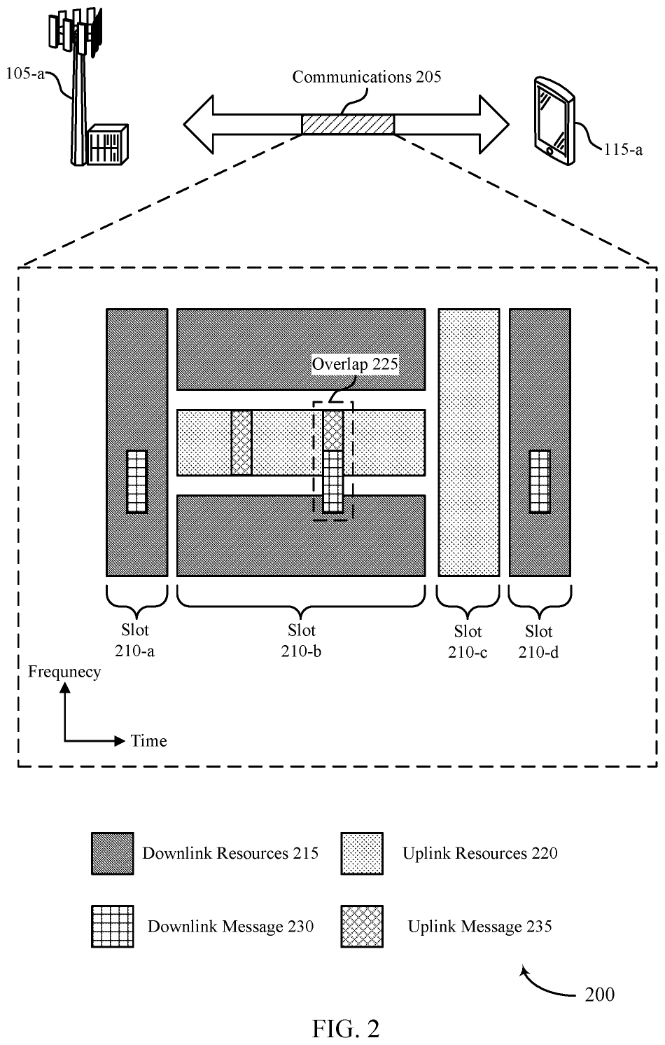

FIG. 2 shows an example of a wireless communications system 200 that supports frequency adjustment for SBFD conflict handling in accordance with one or more aspects of the present disclosure. The wireless communications system 200 may implement, or be implemented by, one or more aspects of the wireless communications system 100. For example, the wireless communications system 200 may include a network entity 105-a and the UE 115-a, which may be examples of corresponding devices described with reference to FIG. 1. In some cases, the wireless communications system 200 may support the UE 115-a and the network entity 105-a performing communications 205, which may include uplink communications (e.g., transmissions by the UE 115-a and receptions by the network entity 105-a) and downlink communications (e.g., transmissions by the network entity 105-a and receptions by the UE 115-a).

The UE 115-a and the network entity 105-a may perform the communications 205 via a set of time-frequency resources. For example, the UE 115-a and the network entity 105-a may communicate, in the time domain, during a set of slots 210 including a slot 210-a, a slot 210-b, a slot 210-c, and a slot 210-b. In some examples, each slot 210 may be associated with one or more communication directions between the UE 115-a and the network entity 105-a. For example, the slot 210-a and the slot 210-d may be examples of downlink slots (e.g., associated with downlink resources 215), the slot 210-c may be an example of an uplink slot (e.g., associated with uplink resources 220), and the slot 210-b may be an example of an SBFD slot (e.g., associated with both downlink resources 215 and uplink resources 220).

In some examples, the UE 115-a may receive, from the network entity 105-a, a resource allocation for one or more uplink messages 235. For example, the network entity 105-a may schedule the one or more uplink messages 235 for transmission by the UE 115-a during respective symbols the slot 210-b and within an uplink sub-band of the slot 210-b. Such messages may be scheduled dynamically, may be based on a periodic configuration, or may be activated from a semi-persistent configuration. For example, the uplink message 235 may be scheduled for transmission by the UE 115-a according to scheduling by the network entity 105-a, a configuration for the uplink message 235, in response to a measurement by the UE 115-a, based on a priority rule for the UE 115-a, or any combination thereof. In some examples, due to the slot 210-b being configured for SBFD communications, the UE 115-a may identify a resource allocation for a downlink message 230 that is scheduled for communication at the same symbol as an uplink message 235. For example, the UE 115-a may receive an indication from the network entity 105-a of the resource allocation for the downlink message 230.

In some examples, the resource allocation for the downlink message 230 may extend into the uplink sub-band (or a guard band for the uplink sub-band) of the slot 210-b, which may result in an overlap 225 (e.g., a collision) between frequency resources allocated to the downlink message 230 and frequency resources allocated to the uplink message 235. For example, if the downlink message 230 is a periodic downlink signal (e.g., an SSB), the network entity 105-a may allocate resources for each transmission of the downlink message 230 prior to scheduling the uplink message 235. As such, a frequency resource allocation for the downlink message 230 may be within the downlink resources 215 of the downlink slot 210-a and the downlink slot 210-d, but may extend into uplink resources 220 of the SBFD slot 210-d (e.g., without dynamic adjustment from the network entity 105-a).

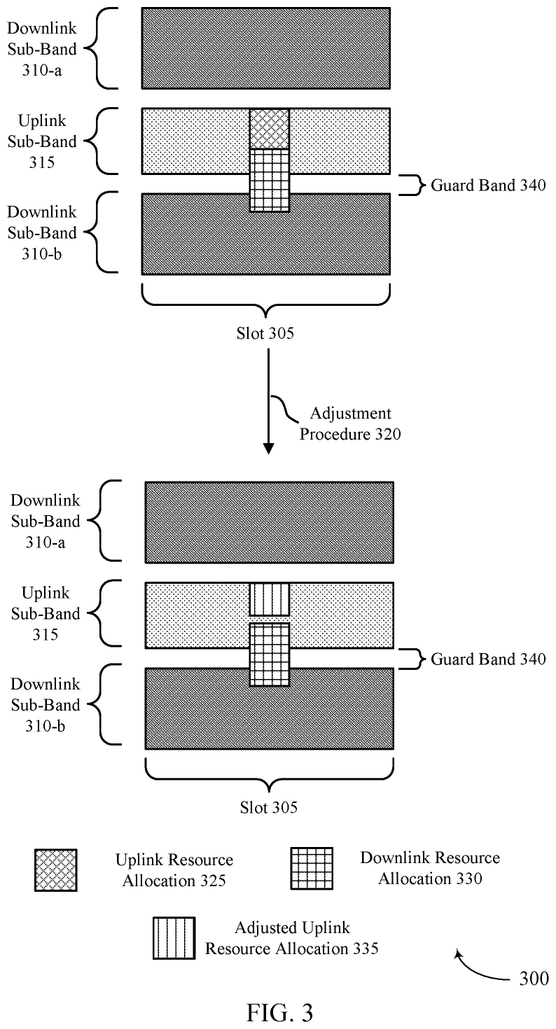

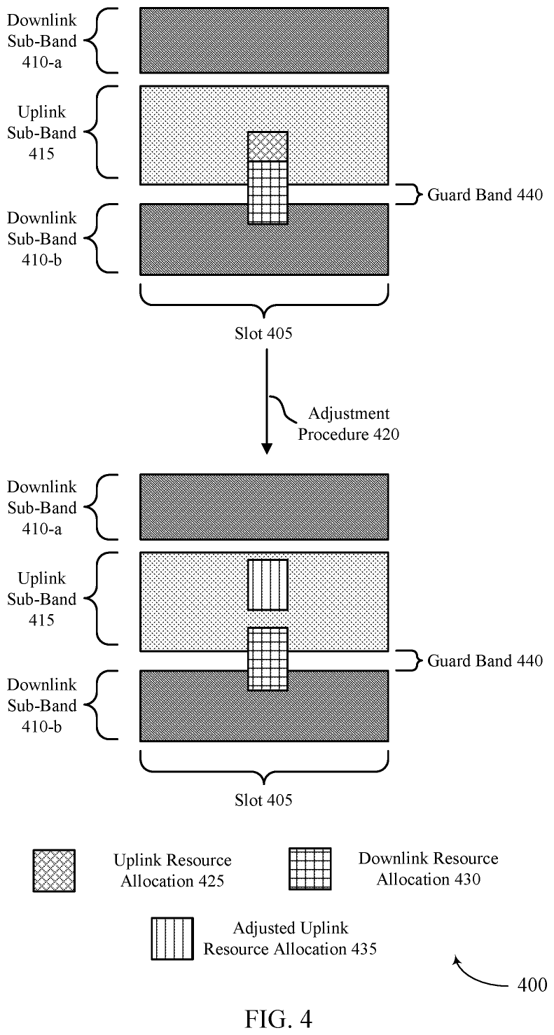

In some cases, the UE 115-a may perform an adjustment procedure for a resource allocation for an uplink message 235 that collides with a downlink message 230 during an SBFD slot (e.g., the slot 210-b). As an example of the adjustment procedure, the UE 115-a may select a new frequency resource allocation for the uplink message 235 from a portion of the original frequency resource allocation for the uplink message 235 that does not overlap the downlink message 230, as described below with reference to FIG. 3. As another example of the adjustment procedure, the UE 115-a may shift the frequency resource allocation for the uplink message 235 within the uplink sub-band of the SBFD slot 210, as described below with reference to FIG. 4.

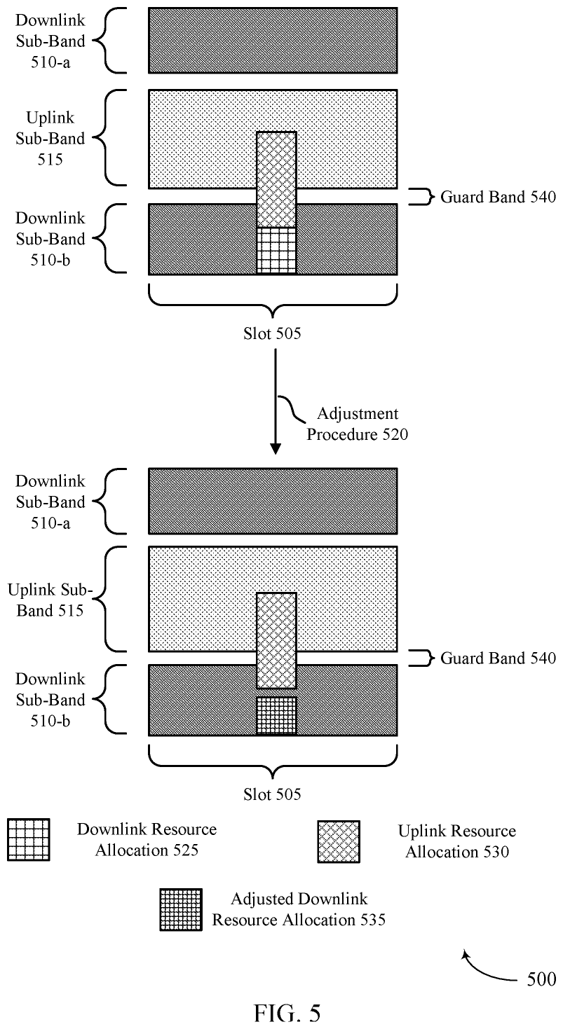

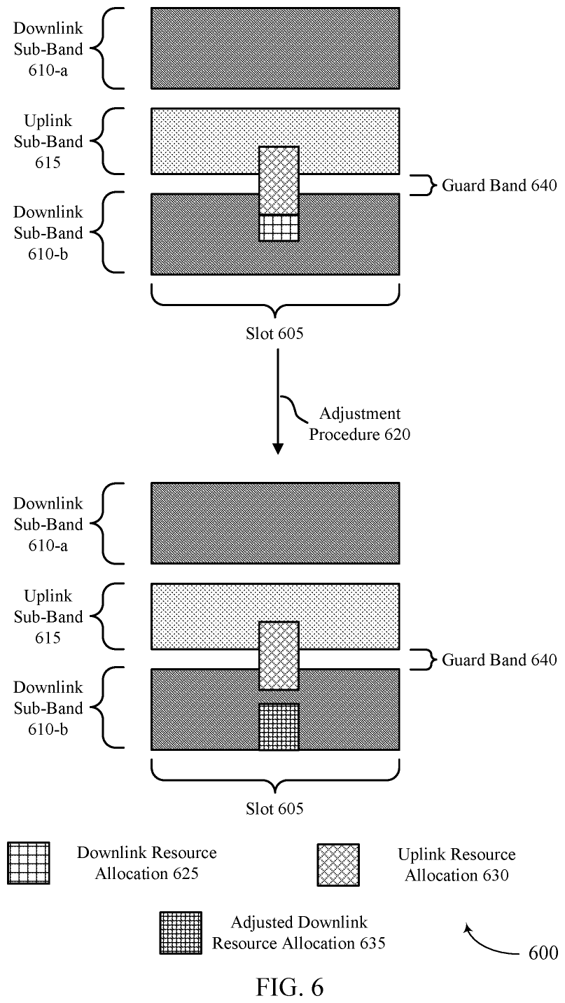

Additionally, or alternatively, the UE 115-a may perform such adjustments for the resource allocation for the downlink message 230 (e.g., while not changing the frequency allocation for the uplink message 235). For example, the UE 115-a may determine to adjust the frequency allocation for the downlink message 230 based on a type of the downlink message 230 (e.g., if the downlink message 230 is not an SSB), the frequency allocation for the uplink message 235 extending into a downlink sub-band of the SBFD slot 210-b, or both. In such examples, the UE 115-a may perform the adjustment procedures for the downlink message 230, as described below with reference to FIGS. 5 and 6.

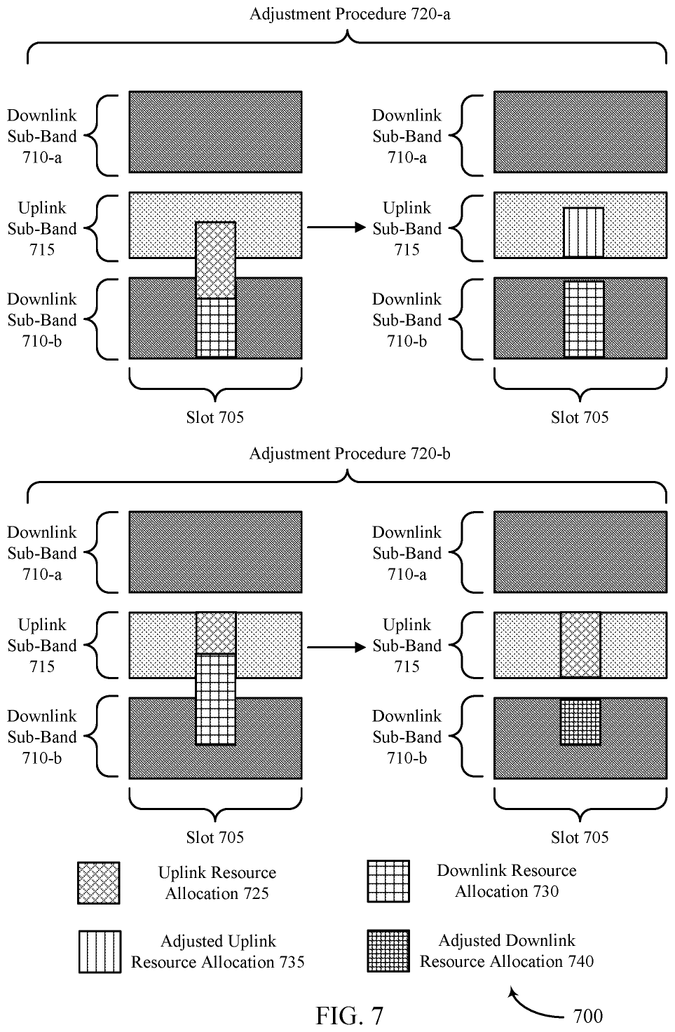

In some cases, the UE 115-a may adjust frequency resources for various combinations of types of messages, such as a dynamically scheduled uplink message 235 and a periodic or semi-persistent downlink message 230, a periodic or semi-persistent uplink message 235 and a dynamically scheduled downlink message 230, or a periodic or semi-persistent uplink message 235 and a periodic or semi-persistent downlink message 230. If both the downlink message 230 and the uplink message 235 are dynamically scheduled by the network entity 105-a, the overlap 225 may be avoided by the network entity 105-a scheduling (e.g., by not selecting colliding resources). In some examples, the UE 115-a may adjust frequency resources according to which message (e.g., the downlink message 230 or the uplink message 235) extends outside of an associated sub-band, as described with reference to FIG. 7.

In some cases, the UE 115-a may determine (e.g., autonomously after identifying the overlap 225) a type of the adjustment procedure to apply based on one or more rules. For example, the UE 115-a may identify one or more preconfigured rules (e.g., rules predefined in a standard) for selecting an adjustment procedure from one or more candidate adjustment procedures. In some cases, the one or more rules may indicate which adjustment procedure to use according to the overlap 225 (e.g., a quantity of overlapping RBs), a configuration of the SBFD slot 210-b (e.g., a quantity of RBs allocated to each sub-band), or both.

Additionally, or alternatively, the network entity 105-a may transmit, to the UE 115-a, a message indicating a type of adjustment procedure to apply (e.g., should an overlap 225 occur). In some examples, the network entity 105-a may transmit such information via an RRC message (e.g., for periodic code group occasions that may overlap with SSB occasions), a media access control control element (MAC-CE), or a downlink control information (DCI) message. In some examples, the network entity 105-a may transmit the message as a UE specific message (e.g., specific to the UE 115-a), a group common message (e.g., transmitted to a group of UEs 115 including the UE 115-a), a broadcast message (e.g., transmitted to each UE 115 in a cell serving the UE 115-a), or any combination thereof.

FIG. 3 shows an example of a resource diagram 300 that supports frequency adjustment for SBFD conflict handling in accordance with one or more aspects of the present disclosure. The resource diagram 300 may implement, or be implemented by, one or more aspects of the wireless communications systems 100 and 200. For example, the resource diagram 300 may support communications between a UE 115 and a network entity 105 during a slot 305, which may be examples of corresponding devices described with reference to FIGS. 1 and 2. In some cases, the slot 305 may be an example of an SBFD slot, such as the slot 210-b described with reference to FIG. 2. For example, the slot 305 may include a downlink sub-band 310-a and a downlink sub-band 310-b for communicating downlink signaling, as well as an uplink sub-band 315 for communicating uplink signaling. It should be noted that the slot 305 may support any configuration or ordering of sub-bands supported by SBFD, and is therefore not limited to the example illustrated by FIG. 3.

The resource diagram 300 illustrates an adjustment procedure 320, which may be a first example of an adjustment procedure for handling resource collision in an SBFD slot. The adjustment procedure 320 may be performed for an uplink resource allocation 325 (e.g., for communicating an uplink message). In some cases, a UE 115 may perform the adjustment procedure 320 based on an overlap between the uplink resource allocation 325 and a downlink resource allocation 330 (e.g., for communicating a downlink message). For example, the downlink resource allocation 330 may be configured for a periodic SSB, and may extend into the uplink sub-band 315 (or a guard band 340 between the downlink sub-band 310-b and the uplink sub-band 315) during the SBFD slot 305. In such examples, if the uplink resource allocation 325 occupies the entire uplink sub-band 315, the downlink resource allocation 330 may overlap the uplink resource allocation 325.

To avoid interference due to the overlap between the downlink resource allocation 330 and the uplink resource allocation 325, the UE 115 may perform the adjustment procedure 320 for the uplink resource allocation 325 to obtain an adjusted uplink resource allocation 335 (e.g., an adjustment to resources used for transmission of an uplink message). The adjustment procedure 320 may include selecting resources for the adjusted uplink resource allocation 335 from the original uplink resource allocation 325 such that a resource separation (e.g., in frequency) between the adjusted uplink resource allocation 335 and the downlink resource allocation 330 satisfies a same quantity of RBs as the guard band 340 (e.g., a threshold quantity of N RBs). For example, as part of the adjustment procedure 320, the UE 115 may select the resources for the adjusted uplink resource allocation 335 from a portion of the uplink resource allocation 325 that does not overlap the downlink resource allocation 330 (e.g., using N RBs of the portion as a guard band and the remaining RBs of the portion for the adjusted uplink resource allocation 335).

In some cases, the UE 115 may adjust a data rate for the uplink message due to performing the adjustment procedure 320. For example, the adjusted uplink resource allocation 335 may include less frequency resources (e.g., RBs) than the uplink resource allocation 325, and the UE 115 may reduce a data rate for the uplink message to support transmission of the data using the reduced quantity of frequency resources. As an alternative, the UE 115 may apply uplink rate matching to the adjusted uplink resource allocation 335, which may allow the UE 115 to maintain a same data rate for transmitting the uplink message (e.g., the same as an original data rate configured for the uplink message). For example, the UE 115 may indicate, to the network entity 105, a capability of the UE 115 to perform the uplink rate matching and may transmit the uplink message via the adjusted uplink resource allocation 335 after applying the uplink rate matching.

FIG. 4 shows an example of a resource diagram 400 that supports frequency adjustment for SBFD conflict handling in accordance with one or more aspects of the present disclosure. The resource diagram 400 may implement, or be implemented by, one or more aspects of the wireless communications systems 100 and 200. For example, the resource diagram 400 may support communications between a UE 115 and a network entity 105 during a slot 405, which may be examples of corresponding devices described with reference to FIGS. 1 and 2. In some cases, the slot 405 may be an example of an SBFD slot, such as the slot 210-b described with reference to FIG. 2. For example, the slot 405 may include a downlink sub-band 410-a and a downlink sub-band 410-b for communicating downlink signaling, as well as an uplink sub-band 415 for communicating uplink signaling. It should be noted that the slot 405 may support any configuration or ordering of sub-bands supported by SBFD, and is therefore not limited to the example illustrated by FIG. 4.

The resource diagram 400 illustrates an adjustment procedure 420, which may be a second example of an adjustment procedure for handling resource collision in an SBFD slot. The adjustment procedure 420 may be performed for an uplink resource allocation 425 (e.g., for communicating an uplink message). In some cases, a UE 115 may perform the adjustment procedure 420 based on an overlap between the uplink resource allocation 425 and a downlink resource allocation 430 (e.g., for communicating a downlink message). For example, the downlink resource allocation 430 may be configured for a periodic SSB, and may extend into the uplink sub-band 415 (or a guard band 440 between the downlink sub-band 410-b and the uplink sub-band 415) during the SBFD slot 405. In such examples, the downlink resource allocation 430 may overlap the uplink resource allocation 425 within the uplink sub-band 415.

To avoid interference due to the overlap between the downlink resource allocation 430 and the uplink resource allocation 425, the UE 115 may perform the adjustment procedure 420 for the uplink resource allocation 425 to obtain an adjusted uplink resource allocation 435 (e.g., an adjustment to resources used for transmission of an uplink message). The adjustment procedure 420 may include the UE 115 shifting the uplink resource allocation 425 within the uplink sub-band 415 to obtain the adjusted uplink resource allocation 435. For example, the UE 115 may identify a remaining quantity of RBs of the uplink sub-band 415 that are not part of the uplink resource allocation 425 (e.g., available RBs), and may shift the uplink resource allocation 425 to occupy the available RBs such that the adjusted uplink resource allocation 435 and the downlink resource allocation 430 do not overlap (e.g., shifting the uplink resource allocation 425 away from the downlink resource allocation 430).

Additionally, the UE 115 may shift the uplink resource allocation 425 such that a resource separation between the adjusted uplink resource allocation 435 and the downlink resource allocation 430 satisfies a same quantity of RBs as the guard band 440 (e.g., a threshold quantity of N RBs). In such examples, the UE 115 may maintain a same data rate for transmission of the uplink message due to the uplink resource allocation 425 and the adjusted uplink resource allocation 435 including a same quantity of RBs.

FIG. 5 shows an example of a resource diagram 500 that supports frequency adjustment for SBFD conflict handling in accordance with one or more aspects of the present disclosure. The resource diagram 500 may implement, or be implemented by, one or more aspects of the wireless communications systems 100 and 200. For example, the resource diagram 500 may support communications between a UE 115 and a network entity 105 during a slot 505, which may be examples of corresponding devices described with reference to FIGS. 1 and 2. In some cases, the slot 505 may be an example of an SBFD slot, such as the slot 210-b described with reference to FIG. 2. For example, the slot 505 may include a downlink sub-band 510-a and a downlink sub-band 510-b for communicating downlink signaling, as well as an uplink sub-band 515 for communicating uplink signaling. It should be noted that the slot 505 may support any configuration or ordering of sub-bands supported by SBFD, and is therefore not limited to the example illustrated by FIG. 5.

The resource diagram 500 illustrates an adjustment procedure 520, which may be a third example of an adjustment procedure for handling resource collision in an SBFD slot. The adjustment procedure 520 may be performed for a downlink resource allocation 525 (e.g., for communicating a downlink message). In some cases, the adjustment procedure 520 may be performed for the downlink resource allocation 525 based on a type of downlink message associated with the downlink resource allocation 525 (e.g., if the downlink message is not an SSB). In some cases, a UE 115 may perform the adjustment procedure 520 based on an overlap between the downlink resource allocation 525 and an uplink resource allocation 530 (e.g., for communicating an uplink message). For example, the uplink resource allocation 530 may extend into the downlink sub-band 510-b (or a guard band 540 between the downlink sub-band 510-b and the uplink sub-band 515) during the SBFD slot 505. In such examples, if the downlink resource allocation 525 occupies the entire downlink sub-band 510-b, the uplink resource allocation 530 may overlap the downlink resource allocation 525.

To avoid interference due to the overlap between the downlink resource allocation 525 and the uplink resource allocation 530, the UE 115 may perform the adjustment procedure 520 for the downlink resource allocation 525 to obtain an adjusted downlink resource allocation 535 (e.g., an adjustment to resources monitored for reception of a downlink message). The adjustment procedure 520 may include selecting resources for the adjusted downlink resource allocation 535 from the original downlink resource allocation 525 such that a resource separation (e.g., in frequency) between the adjusted downlink resource allocation 535 and the uplink resource allocation 530 satisfies a same quantity of RBs as the guard band 540 (e.g., a threshold quantity of N RBs). For example, as part of the adjustment procedure 520, the UE 115 may select the resources for the adjusted downlink resource allocation 535 from a portion of the downlink resource allocation 525 that does not overlap the uplink resource allocation 530 (e.g., using N RBs of the portion as a guard band and the remaining RBs of the portion for the downlink resource allocation 535).

In some cases, the UE 115 may adjust a data rate for the downlink message due to performing the adjustment procedure 520. For example, the adjusted downlink resource allocation 535 may include less frequency resources (e.g., RBs) than the downlink resource allocation 525, and the UE 115 may reduce a data rate when monitoring for the downlink message to support reception of the data using the reduced quantity of frequency resources. As an alternative, the UE 115 may apply downlink rate matching to the adjusted downlink resource allocation 535, which may allow the UE 115 to maintain a same data rate for receiving the downlink message (e.g., the same as an original data rate configured for the downlink message).

FIG. 6 shows an example of a resource diagram 600 that supports frequency adjustment for SBFD conflict handling in accordance with one or more aspects of the present disclosure. The resource diagram 600 may implement, or be implemented by, one or more aspects of the wireless communications systems 100 and 200. For example, the resource diagram 600 may support communications between a UE 115 and a network entity 105 during a slot 605, which may be examples of corresponding devices described with reference to FIGS. 1 and 2. In some cases, the slot 605 may be an example of an SBFD slot, such as the slot 210-b described with reference to FIG. 2. For example, the slot 605 may include a downlink sub-band 610-a and a downlink sub-band 610-b for communicating downlink signaling, as well as an uplink sub-band 615 for communicating uplink signaling. It should be noted that the slot 605 may support any configuration or ordering of sub-bands supported by SBFD, and is therefore not limited to the example illustrated by FIG. 6.

The resource diagram 600 illustrates an adjustment procedure 620, which may be a fourth example of an adjustment procedure for handling resource collision in an SBFD slot. The adjustment procedure 620 may be performed for a downlink resource allocation 625 (e.g., for communicating a downlink message). In some cases, the adjustment procedure 620 may be performed for the downlink resource allocation 625 based on a type of downlink message associated with the downlink resource allocation 625 (e.g., if the downlink message is not an SSB). In some cases, a UE 115 may perform the adjustment procedure 620 based on an overlap between the downlink resource allocation 625 and an uplink resource allocation 630 (e.g., for communicating an uplink message). For example, the uplink resource allocation 630 may extend into the downlink sub-band 610-b (or a guard band 640 between the downlink sub-band 610-b and the uplink sub-band 615) during the SBFD slot 605. In such examples, the downlink resource allocation 625 may overlap the uplink resource allocation 630 within the downlink sub-band 610-b.

To avoid interference due to the overlap between the downlink resource allocation 625 and the uplink resource allocation 630, the UE 115 may perform the adjustment procedure 620 for the downlink resource allocation 625 to obtain an adjusted downlink resource allocation 635 (e.g., an adjustment to resources monitored for reception of a downlink message). The adjustment procedure 620 may include the UE 115 shifting the downlink resource allocation 625 within the downlink sub-band 610-b to obtain the adjusted downlink resource allocation 635. For example, the UE 115 may identify a remaining quantity of RBs of the downlink sub-band 610-b that are not part of the downlink resource allocation 625 (e.g., available RBs), and may shift the downlink resource allocation 625 to occupy the available RBs such that the adjusted downlink resource allocation 635 and the uplink resource allocation 630 do not overlap (e.g., shifting the downlink resource allocation 625 to frequency resources that are different from the uplink resource allocation 630).

Additionally, the UE 115 may shift the downlink resource allocation 625 such that a resource separation between the adjusted downlink resource allocation 635 and the uplink resource allocation 630 satisfies a same quantity of RBs as the guard band 640 (e.g., a threshold quantity of N RBs). In such examples, the UE 115 may maintain a same data rate for reception of the downlink message due to the downlink resource allocation 625 and the adjusted downlink resource allocation 635 including a same quantity of RBs.

FIG. 7 shows an example of a resource diagram 700 that supports frequency adjustment for SBFD conflict handling in accordance with one or more aspects of the present disclosure. The resource diagram 700 may implement, or be implemented by, one or more aspects of the wireless communications systems 100 and 200. For example, the resource diagram 700 may support communications between a UE 115 and a network entity 105 during a slot 705, which may be examples of corresponding devices described with reference to FIGS. 1 and 2. In some cases, the slot 705 may be an example of an SBFD slot, such as the slot 210-b described with reference to FIG. 2. For example, the slot 705 may include a downlink sub-band 710-a and a downlink sub-band 710-b for communicating downlink signaling, as well as an uplink sub-band 715 for communicating uplink signaling. It should be noted that the slot 705 may support any configuration or ordering of sub-bands supported by SBFD, and is therefore not limited to the example illustrated by FIG. 7.

The resource diagram 700 illustrates an adjustment procedure 720, which may be a fifth example of an adjustment procedure for handling resource collision in an SBFD slot. The adjustment procedure 720 may be performed for an uplink resource allocation 725 (e.g., for communicating an uplink message) or for a downlink resource allocation 730 (e.g., for communicating a downlink message) based on which resource allocation extends outside of an associated sub-band. For example, a UE 115 may perform an adjustment procedure 720-a for the uplink resource allocation 725 to obtain an adjusted uplink resource allocation 735 if the uplink resource allocation 725 extends into the downlink sub-band 710-b (or a guard band between the uplink sub-band 715 and the downlink sub-band 710-b) and overlaps the downlink resource allocation 730. Alternatively, the UE 115 may perform an adjustment procedure 720-b for the downlink resource allocation 730 to obtain an adjusted downlink resource allocation 740 if the downlink resource allocation 730 extends into the uplink sub-band 715 (or a guard band between the uplink sub-band 715 and the downlink sub-band 710-b) and overlaps the uplink resource allocation 725.

In some cases, the adjustment procedure 720 may be an example of the adjustment procedures described with reference to FIGS. 3-6. For example, the adjustment procedure 720-a may include the UE 115 selecting the adjusted uplink resource allocation 735 from the uplink resource allocation 725 (e.g., with or without applying rate matching), as described with reference to FIG. 3. Alternatively, the adjustment procedure 720-a may include the UE 115 shifting the uplink resource allocation 725 away from the downlink resource allocation 730 (e.g., shifted to the uplink sub-band 715) to obtain the adjusted uplink resource allocation 735, as described with reference to FIG. 4. Similarly, the adjustment procedure 720-b may include the UE 115 selecting the adjusted downlink resource allocation 740 from the downlink resource allocation 730 (e.g., with or without applying rate matching), as described with reference to FIG. 5. Alternatively, the adjustment procedure 720-b may include the UE 115 shifting the downlink resource allocation 730 away from the uplink resource allocation 725 (e.g., shifted to the downlink sub-band 710-b) to obtain the adjusted downlink resource allocation 740, as described with reference to FIG. 6.

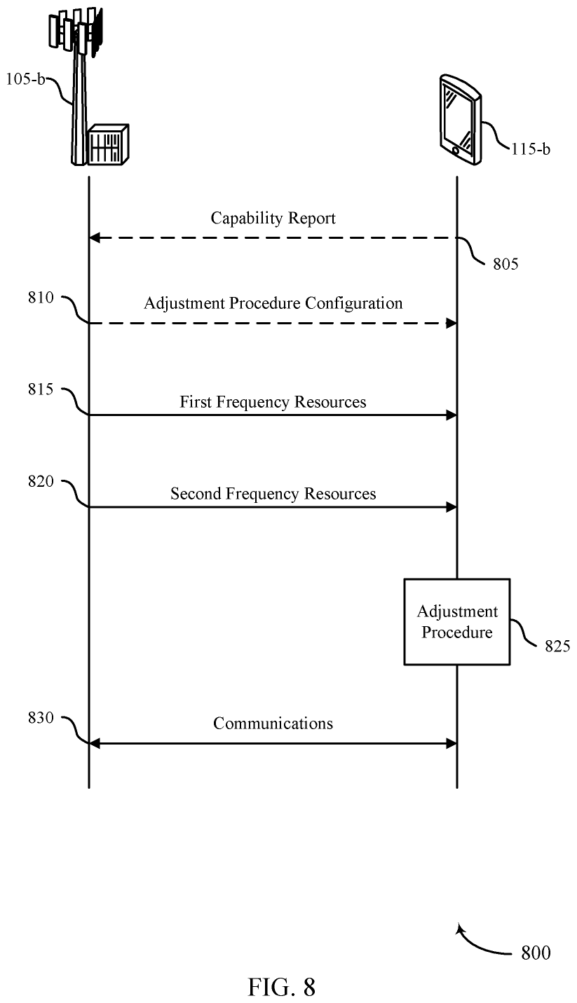

FIG. 8 shows an example of a process flow 800 that supports frequency adjustment for SBFD conflict handling in accordance with one or more aspects of the present disclosure. The process flow 800 may implement, or be implemented by, one or more aspects of the wireless communications systems 100 and 200, as well as the resource diagrams 300, 400, 500, 600, and 700. For example, the process flow 800 may be an example of signaling between a UE 115-b and a network entity 105-b to handle frequency resource collisions during an SBFD slot using techniques described with reference to FIGS. 1 through 7. Alternative examples of the following may be implemented, where some processes are performed in a different order than described or are not performed. In some cases, processes may include additional features not mentioned below, or further processes may be added.

At 805, the UE 115-b may transmit a capability report to the network entity 105-b indicating one or more capabilities of the UE 115-b. For example, the capability report may indicate a capability of the UE 115-b to apply rate matching (e.g., uplink rate matching or downlink rate matching).

At 810, the network entity 105-b may transmit a control message (which may be referred to as a third control message herein) indicating an adjustment procedure configuration to the UE 115-b. For example, the network entity 105-b may configure the UE 115-b with one or more types of adjustment procedure the UE 115-b is to use should a resource collision occur. In some cases, the type may indicate that the UE 115-b is to select a new resource allocation from the original resource allocation, shift the original resource allocation to obtain the new resource allocation, or both. In some cases, the control message may be specific to the UE 115-b, may be associated with a group of UEs 115 including the UE 115-b, or broadcast to each UE 115 of a cell including the UE 115-b.

At 815, the network entity 105-b may transmit, to the UE 115-b, a first control message indicating one or more first frequency resources associated with a first signal having a first communication direction between the UE 115-b and the network entity 105-b (e.g., uplink or downlink) and allocated within an SBFD slot. For example, the one or more first frequency resources may indicate an uplink resource allocation for the UE 115-b to transmit an uplink message. Alternatively, the one or more first frequency resources may indicate a downlink resource allocation for the UE 115-b to monitor for a downlink message. In some cases, the first control message may dynamically schedule the first signal or may activate the first signal for semi-persistent scheduling.

At 820, the network entity 105-b may transmit, to the UE 115-b, a second control message indicating one or more second frequency resource associated with a second signal having a second communication direction between the UE 115-b and the network entity 105-b that is different from the first communication direction. In some cases, the one or more second frequency resources may be allocated within the SBFD slot at a same symbol (e.g., in a time domain) as the one or more first frequency resources and may at least partially overlap the one or more frequency resources in a frequency domain. In some cases, the first signal may be dynamically scheduled and the second signal may be periodically scheduled or semi-persistently scheduled. Alternatively, the first signal may be periodically scheduled or semi-persistently scheduled and the second signal may be dynamically scheduled. Alternatively, the first signal may be periodically scheduled or semi-persistently scheduled and the second signal may be periodically scheduled or semi-persistently scheduled.

At 825, the UE 115-b may perform an adjustment procedure for the one or more first frequency resources to obtain one or more third frequency resources for communication of the first signal. In some cases, performing the adjustment procedure may be based on the one or more second frequency resources at least partially overlapping the one or more first frequency resources in the frequency domain. In some cases, the UE 115-b may use the adjustment procedure indicated by the network entity 105-b. Alternatively, the UE 115-b may select (e.g., autonomously) a type of the adjustment procedure from a set of multiple types of adjustment procedures in accordance with one or more rules (e.g., predefined in a standard) that are based on the one or more second frequency resources at least partially overlapping the one or more first frequency resources in the frequency domain.

In some cases, the one or more first frequency resources and the one or more third frequency resources may be allocated within a first sub-band of the SBFD slot configured for the first communication direction and the one or more second frequency resources may be allocated at least partially within the first sub-band or at least partially within a guard band between the first sub-band and a second sub-band of the SBFD slot configured for the second communication direction (e.g., extending out of an associated sub-band). In such examples, the UE 115-b may adjust the one or more first frequency resources (e.g., to accommodate the one or more second frequency resources extending into the first sub-band).

For example, the UE 115-b may perform the adjustment procedure by selecting the one or more third frequency resources from the one or more first frequency resources (e.g., a subset of the one or more first frequency resources), where a resource separation between the one or more third frequency resources and the one or more second frequency resources in the frequency domain may satisfy a threshold quantity of RBs corresponding to a size of the guard band. Further, the UE 115-b may select the one or more third frequency resources from a portion of the one or more first frequency resources that does not overlap the one or more second frequency resources. In some cases, the UE 115-b may reduce a data rate for the first signal based on the one or more third frequency resources include less RBs then the one or more first frequency resources. Alternatively, the UE 115-b may apply rate matching to the one or more third frequency resources to maintain a same data rate configured for the first signal (e.g., based on indicating the capability report).

As another example, the UE 115-b may perform the adjustment procedure by shifting, within the first sub-band, the one or more first frequency resources to obtain the one or more third frequency resources. In some cases, the one or more first frequency resources and the one or more third frequency resources may include a same quantity of RBs (e.g., maintaining a same data rate for the first signal). For example, the UE 115-b may shift the one or more first frequency resources away from the one or more second frequency resources within the first sub-band such that the one or more third frequency resources and the one or more second frequency resources do not overlap.

As another example, the one or more second frequency resources may be allocated within the second sub-band of the SBFD slot configured for the second communication direction and the one or more first frequency resources may be allocated at least partially within the second sub-band (e.g., extending out of an associated sub-band). In such examples, the UE 115-b may perform the adjustment procedure for the one or more first frequency resources based on the one or more first frequency resources being allocated at least partially within the second sub-band. In other words, the UE 115-b may perform the adjustment procedure for resources that extend into an incorrect sub-band (e.g., uplink resources in a downlink sub-band or downlink resources in an uplink sub-band).

At 830, the UE 115-b and the network entity 105-b may communicate the first signal via the one or more third frequency resources, the second signal via the one or more second frequency resources, or both, during the SBFD slot in accordance with the adjustment procedure. In some cases, interference due to the overlap between the one or more first frequency resources and the one or more second frequency resources may be avoided due to performing the adjustment procedure on the one or more first frequency resources.

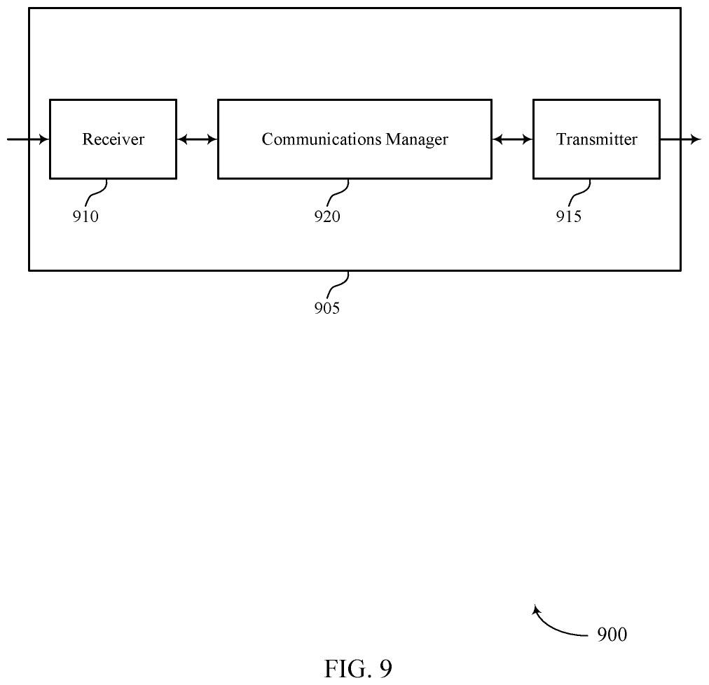

FIG. 9 shows a block diagram 900 of a device 905 that supports frequency adjustment for SBFD conflict handling in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to frequency adjustment for SBFD conflict handling). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to frequency adjustment for SBFD conflict handling). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of frequency adjustment for SBFD conflict handling as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving a first indication of one or more first frequency resources associated with a SSB, the one or more first frequency resources allocated within a SBFD slot. The communications manager 920 is capable of, configured to, or operable to support a means for receiving a second indication of one or more second frequency resources associated with an uplink message for transmission by the UE, where the one or more second frequency resources are allocated within the SBFD slot and at least partially overlap the one or more first frequency resources in a frequency domain. The communications manager 920 is capable of, configured to, or operable to support a means for performing, based on the one or more second frequency resources at least partially overlapping with the one or more first frequency resources in the frequency domain, an adjustment procedure for the one or more second frequency resources to obtain one or more third frequency resources for transmission of the uplink message by the UE, where the one or more third frequency resources are within the SBFD slot and are separate from the one or more first frequency resources in the frequency domain. The communications manager 920 is capable of, configured to, or operable to support a means for transmitting, in accordance with the adjustment procedure, the uplink message via the one or more third frequency resources during the SBFD slot.

Additionally, or alternatively, the communications manager 920 may support wireless communications in accordance with examples as disclosed herein. For example, the communications manager 920 is capable of, configured to, or operable to support a means for receiving, from a network entity, a first control message indicating one or more first frequency resources associated with a first signal having a first communication direction between the UE and the network entity, the one or more first frequency resource allocated within a SBFD slot. The communications manager 920 is capable of, configured to, or operable to support a means for receiving, from the network entity, a second control message indicating one or more second frequency resources associated with a second signal having a second communication direction between the UE and the network entity that is different from the first communication direction, where the one or more second frequency resources are allocated within the SBFD slot and at least partially overlap the one or more first frequency resources in a frequency domain. The communications manager 920 is capable of, configured to, or operable to support a means for performing, based on the one or more second frequency resources at least partially overlapping the one or more first frequency resources in the frequency domain, an adjustment procedure for the one or more first frequency resources to obtain one or more third frequency resources for communication of the first signal. The communications manager 920 is capable of, configured to, or operable to support a means for communicating, in accordance with the adjustment procedure, the first signal via the one or more third frequency resources, the second signal via the one or more second frequency resources, or both, during the SBFD slot.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for improving SBFD communications, thereby improving system efficiency, capacity, and latency.

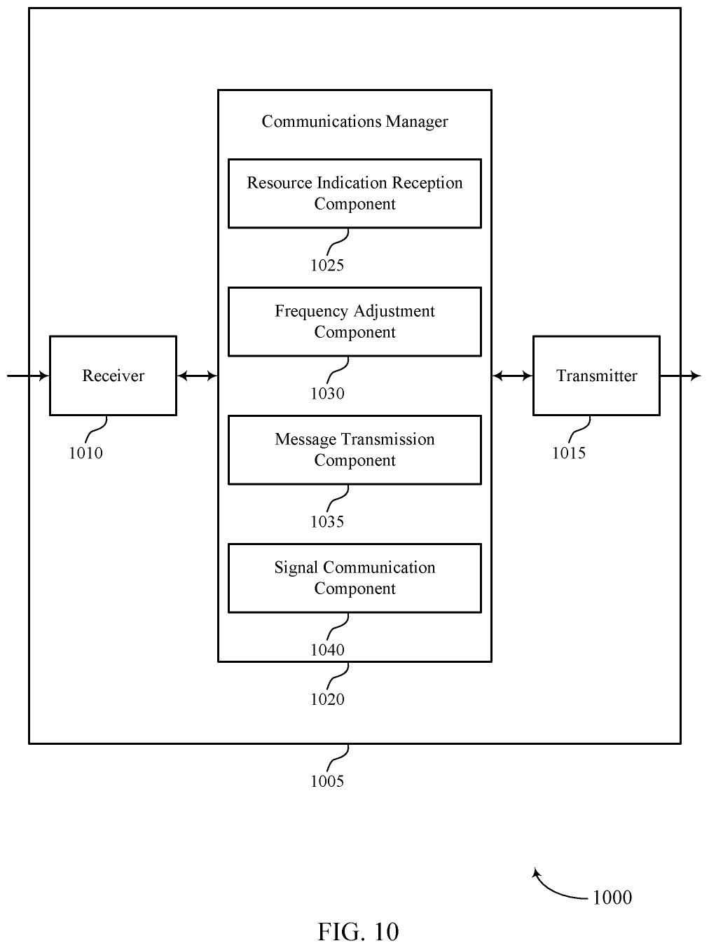

FIG. 10 shows a block diagram 1000 of a device 1005 that supports frequency adjustment for SBFD conflict handling in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to frequency adjustment for SBFD conflict handling). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to frequency adjustment for SBFD conflict handling). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of frequency adjustment for SBFD conflict handling as described herein. For example, the communications manager 1020 may include a resource indication reception component 1025, a frequency adjustment component 1030, a message transmission component 1035, a signal communication component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The resource indication reception component 1025 is capable of, configured to, or operable to support a means for receiving a first indication of one or more first frequency resources associated with a SSB, the one or more first frequency resources allocated within a SBFD slot. The resource indication reception component 1025 is capable of, configured to, or operable to support a means for receiving a second indication of one or more second frequency resources associated with an uplink message for transmission by the UE, where the one or more second frequency resources are allocated within the SBFD slot and at least partially overlap the one or more first frequency resources in a frequency domain. The frequency adjustment component 1030 is capable of, configured to, or operable to support a means for performing, based on the one or more second frequency resources at least partially overlapping with the one or more first frequency resources in the frequency domain, an adjustment procedure for the one or more second frequency resources to obtain one or more third frequency resources for transmission of the uplink message by the UE, where the one or more third frequency resources are within the SBFD slot and are separate from the one or more first frequency resources in the frequency domain. The message transmission component 1035 is capable of, configured to, or operable to support a means for transmitting, in accordance with the adjustment procedure, the uplink message via the one or more third frequency resources during the SBFD slot.

Additionally, or alternatively, the communications manager 1020 may support wireless communications in accordance with examples as disclosed herein. The resource indication reception component 1025 is capable of, configured to, or operable to support a means for receiving, from a network entity, a first control message indicating one or more first frequency resources associated with a first signal having a first communication direction between the UE and the network entity, the one or more first frequency resource allocated within a SBFD slot. The resource indication reception component 1025 is capable of, configured to, or operable to support a means for receiving, from the network entity, a second control message indicating one or more second frequency resources associated with a second signal having a second communication direction between the UE and the network entity that is different from the first communication direction, where the one or more second frequency resources are allocated within the SBFD slot and at least partially overlap the one or more first frequency resources in a frequency domain. The frequency adjustment component 1030 is capable of, configured to, or operable to support a means for performing, based on the one or more second frequency resources at least partially overlapping the one or more first frequency resources in the frequency domain, an adjustment procedure for the one or more first frequency resources to obtain one or more third frequency resources for communication of the first signal. The signal communication component 1040 is capable of, configured to, or operable to support a means for communicating, in accordance with the adjustment procedure, the first signal via the one or more third frequency resources, the second signal via the one or more second frequency resources, or both, during the SBFD slot.

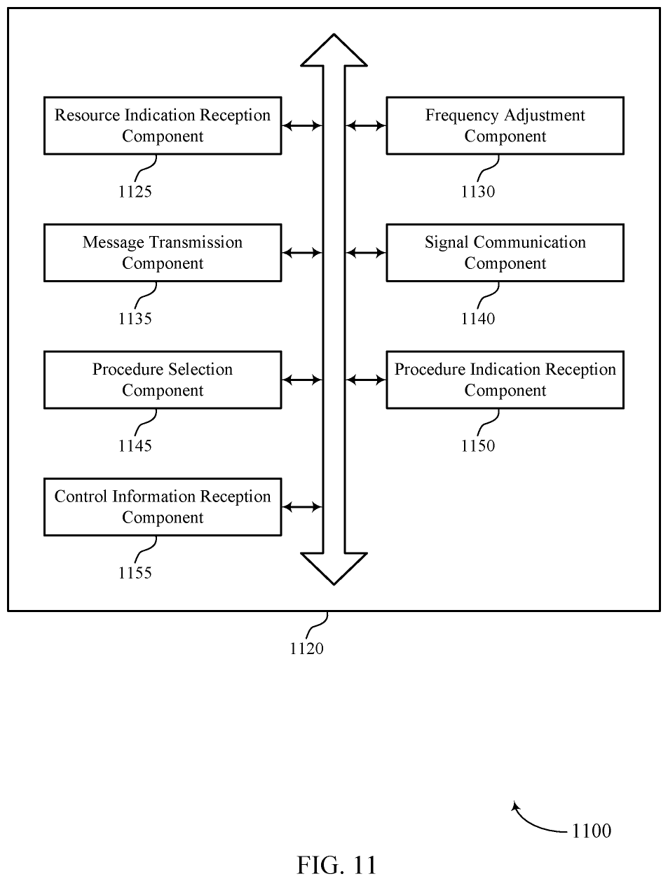

FIG. 11 shows a block diagram 1100 of a communications manager 1120 that supports frequency adjustment for SBFD conflict handling in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of frequency adjustment for SBFD conflict handling as described herein. For example, the communications manager 1120 may include a resource indication reception component 1125, a frequency adjustment component 1130, a message transmission component 1135, a signal communication component 1140, a procedure selection component 1145, a procedure indication reception component 1150, a control information reception component 1155, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The resource indication reception component 1125 is capable of, configured to, or operable to support a means for receiving a first indication of one or more first frequency resources associated with a SSB, the one or more first frequency resources allocated within a SBFD slot. In some examples, the resource indication reception component 1125 is capable of, configured to, or operable to support a means for receiving a second indication of one or more second frequency resources associated with an uplink message for transmission by the UE, where the one or more second frequency resources are allocated within the SBFD slot and at least partially overlap the one or more first frequency resources in a frequency domain. The frequency adjustment component 1130 is capable of, configured to, or operable to support a means for performing, based on the one or more second frequency resources at least partially overlapping with the one or more first frequency resources in the frequency domain, an adjustment procedure for the one or more second frequency resources to obtain one or more third frequency resources for transmission of the uplink message by the UE, where the one or more third frequency resources are within the SBFD slot and are separate from the one or more first frequency resources in the frequency domain. The message transmission component 1135 is capable of, configured to, or operable to support a means for transmitting, in accordance with the adjustment procedure, the uplink message via the one or more third frequency resources during the SBFD slot.

In some examples, the one or more second frequency resources and the one or more third frequency resources are allocated within an uplink sub-band of the SBFD slot; and the one or more first frequency resources are allocated at least partially within the uplink sub-band or at least partially within a guard band between the uplink sub-band and a downlink sub-band of the SBFD slot.

In some examples, to support performing the adjustment procedure, the frequency adjustment component 1130 is capable of, configured to, or operable to support a means for selecting the one or more third frequency resources from the one or more second frequency resources, where a resource separation between the one or more third frequency resources and the one or more first frequency resources in the frequency domain satisfies a threshold quantity of RBs corresponding to a size of the guard band.

In some examples, to support selecting the one or more third frequency resources, the frequency adjustment component 1130 is capable of, configured to, or operable to support a means for selecting the one or more third frequency resources from a portion of the one or more second frequency resources that does not overlap the one or more first frequency resources.

In some examples, to support transmitting the uplink message, the frequency adjustment component 1130 is capable of, configured to, or operable to support a means for applying uplink rate matching to the one or more third frequency resources based on selecting the one or more third frequency resources. In some examples, to support transmitting the uplink message, the message transmission component 1135 is capable of, configured to, or operable to support a means for transmitting the uplink message in accordance with a data rate that is based on applying the uplink rate matching.

In some examples, to support performing the adjustment procedure, the frequency adjustment component 1130 is capable of, configured to, or operable to support a means for shifting, within the uplink sub-band, the one or more second frequency resources to obtain the one or more third frequency resources, where the one or more second frequency resources and the one or more third frequency resources include a same quantity of RBs.

In some examples, the message transmission component 1135 is capable of, configured to, or operable to support a means for transmitting a capability report indicating a capability of the UE to perform uplink rate matching.

In some examples, the procedure selection component 1145 is capable of, configured to, or operable to support a means for selecting a type of the adjustment procedure from a set of multiple types of adjustment procedures in accordance with one or more rules that are based on the one or more second frequency resources at least partially overlapping the one or more first frequency resources in the frequency domain.

In some examples, the procedure indication reception component 1150 is capable of, configured to, or operable to support a means for receiving a control message indicating a type of the adjustment procedure, where the adjustment procedure is performed in accordance with the type.

In some examples, the control information reception component 1155 is capable of, configured to, or operable to support a means for receiving a control signal that dynamically schedules the uplink message or activates the uplink message for semi-persistent scheduling, where the control signal is specific to the UE, associated with a group of UEs including the UE, or broadcast to each UE of a cell including the UE.

Additionally, or alternatively, the communications manager 1120 may support wireless communications in accordance with examples as disclosed herein. In some examples, the resource indication reception component 1125 is capable of, configured to, or operable to support a means for receiving, from a network entity, a first control message indicating one or more first frequency resources associated with a first signal having a first communication direction between the UE and the network entity, the one or more first frequency resource allocated within a SBFD slot. In some examples, the resource indication reception component 1125 is capable of, configured to, or operable to support a means for receiving, from the network entity, a second control message indicating one or more second frequency resources associated with a second signal having a second communication direction between the UE and the network entity that is different from the first communication direction, where the one or more second frequency resources are allocated within the SBFD slot and at least partially overlap the one or more first frequency resources in a frequency domain. In some examples, the frequency adjustment component 1130 is capable of, configured to, or operable to support a means for performing, based on the one or more second frequency resources at least partially overlapping the one or more first frequency resources in the frequency domain, an adjustment procedure for the one or more first frequency resources to obtain one or more third frequency resources for communication of the first signal. The signal communication component 1140 is capable of, configured to, or operable to support a means for communicating, in accordance with the adjustment procedure, the first signal via the one or more third frequency resources, the second signal via the one or more second frequency resources, or both, during the SBFD slot.

In some examples, the one or more first frequency resources and the one or more third frequency resources are allocated within a first sub-band of the SBFD slot configured for the first communication direction; and the one or more second frequency resources are allocated at least partially within the first sub-band or at least partially within a guard band between the first sub-band and a second sub-band of the SBFD slot configured for the second communication direction.

In some examples, to support performing the adjustment procedure, the frequency adjustment component 1130 is capable of, configured to, or operable to support a means for selecting the one or more third frequency resources from the one or more first frequency resources, where a resource separation between the one or more third frequency resources and the one or more second frequency resources in the frequency domain satisfies a threshold quantity of RBs corresponding to a size of the guard band.

In some examples, to support selecting the one or more third frequency resource, the frequency adjustment component 1130 is capable of, configured to, or operable to support a means for selecting the one or more third frequency resource from a portion of the one or more first frequency resources that does not overlap the one or more second frequency resources.

In some examples, to support communicating the first signal, the frequency adjustment component 1130 is capable of, configured to, or operable to support a means for applying the rate matching to the one or more third frequency resources based on selecting the one or more third frequency resources. In some examples, to support communicating the first signal, the signal communication component 1140 is capable of, configured to, or operable to support a means for communicating the first signal in accordance with a data rate that is based on applying the rate matching.

In some examples, to support performing the adjustment procedure, the frequency adjustment component 1130 is capable of, configured to, or operable to support a means for shifting, within the first sub-band, the one or more first frequency resources to obtain the one or more third frequency resources, where the one or more first frequency resources and the one or more third frequency resources include a same quantity of RBs.

In some examples, the one or more second frequency resources are allocated within a first sub-band of the SBFD slot configured for the second communication direction; and the one or more first frequency resources are allocated at least partially within the first sub-band, where performing the adjustment procedure is based on the one or more first frequency resource being allocated at least partially within the first sub-band.

In some examples, the procedure selection component 1145 is capable of, configured to, or operable to support a means for selecting a type of the adjustment procedure from a set of multiple types of adjustment procedures in accordance with one or more rules that are based on the one or more second frequency resources at least partially overlapping the one or more first frequency resources in the frequency domain.

In some examples, the procedure indication reception component 1150 is capable of, configured to, or operable to support a means for receiving a third control message indicating a type of the adjustment procedure, where the adjustment procedure is performed in accordance with the type.

In some examples, the control information reception component 1155 is capable of, configured to, or operable to support a means for receiving a third control message that dynamically schedules the first signal or activates the first signal for semi-persistent scheduling, where the third control message is specific to the UE, associated with a group of UEs including the UE, or broadcast to each UE of a cell including the UE.

In some examples, the first signal is dynamically scheduled and the second signal is periodically scheduled or semi-persistently scheduled; the first signal is periodically scheduled or semi-persistently scheduled and the second signal is dynamically scheduled; or the first signal is periodically scheduled or semi-persistently scheduled and the second signal is periodically scheduled or semi-persistently scheduled.

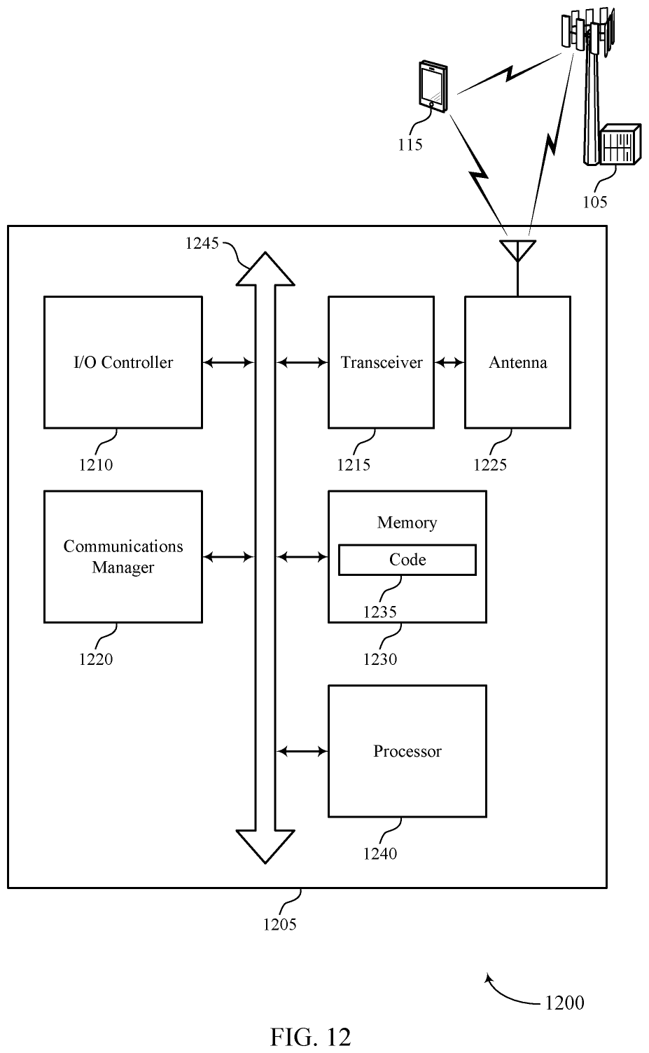

FIG. 12 shows a diagram of a system 1200 including a device 1205 that supports frequency adjustment for SBFD conflict handling in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable code 1235 including instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may contain, among other things, a basic I/O system (BIOS) which may control basic hardware or software operation such as the interaction with peripheral components or devices.

The at least one processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting frequency adjustment for SBFD conflict handling). For example, the device 1205 or a component of the device 1205 may include at least one processor 1240 and at least one memory 1230 coupled with or to the at least one processor 1240, the at least one processor 1240 and at least one memory 1230 configured to perform various functions described herein. In some examples, the at least one processor 1240 may include multiple processors and the at least one memory 1230 may include multiple memories. One or more of the multiple processors may be coupled with one or more of the multiple memories, which may, individually or collectively, be configured to perform various functions herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. As such, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving a first indication of one or more first frequency resources associated with a SSB, the one or more first frequency resources allocated within a SBFD slot. The communications manager 1220 is capable of, configured to, or operable to support a means for receiving a second indication of one or more second frequency resources associated with an uplink message for transmission by the UE, where the one or more second frequency resources are allocated within the SBFD slot and at least partially overlap the one or more first frequency resources in a frequency domain. The communications manager 1220 is capable of, configured to, or operable to support a means for performing, based on the one or more second frequency resources at least partially overlapping with the one or more first frequency resources in the frequency domain, an adjustment procedure for the one or more second frequency resources to obtain one or more third frequency resources for transmission of the uplink message by the UE, where the one or more third frequency resources are within the SBFD slot and are separate from the one or more first frequency resources in the frequency domain. The communications manager 1220 is capable of, configured to, or operable to support a means for transmitting, in accordance with the adjustment procedure, the uplink message via the one or more third frequency resources during the SBFD slot.

Additionally, or alternatively, the communications manager 1220 may support wireless communications in accordance with examples as disclosed herein. For example, the communications manager 1220 is capable of, configured to, or operable to support a means for receiving, from a network entity, a first control message indicating one or more first frequency resources associated with a first signal having a first communication direction between the UE and the network entity, the one or more first frequency resource allocated within a SBFD slot. The communications manager 1220 is capable of, configured to, or operable to support a means for receiving, from the network entity, a second control message indicating one or more second frequency resources associated with a second signal having a second communication direction between the UE and the network entity that is different from the first communication direction, where the one or more second frequency resources are allocated within the SBFD slot and at least partially overlap the one or more first frequency resources in a frequency domain. The communications manager 1220 is capable of, configured to, or operable to support a means for performing, based on the one or more second frequency resources at least partially overlapping the one or more first frequency resources in the frequency domain, an adjustment procedure for the one or more first frequency resources to obtain one or more third frequency resources for communication of the first signal. The communications manager 1220 is capable of, configured to, or operable to support a means for communicating, in accordance with the adjustment procedure, the first signal via the one or more third frequency resources, the second signal via the one or more second frequency resources, or both, during the SBFD slot.

By including or configuring the communications manager 1220 in accordance with examples as described herein, the device 1205 may support techniques for improving SBFD communications, thereby improving system efficiency, capacity, and latency.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of frequency adjustment for SBFD conflict handling as described herein, or the at least one processor 1240 and the at least one memory 1230 may be otherwise configured to, individually or collectively, perform or support such operations.

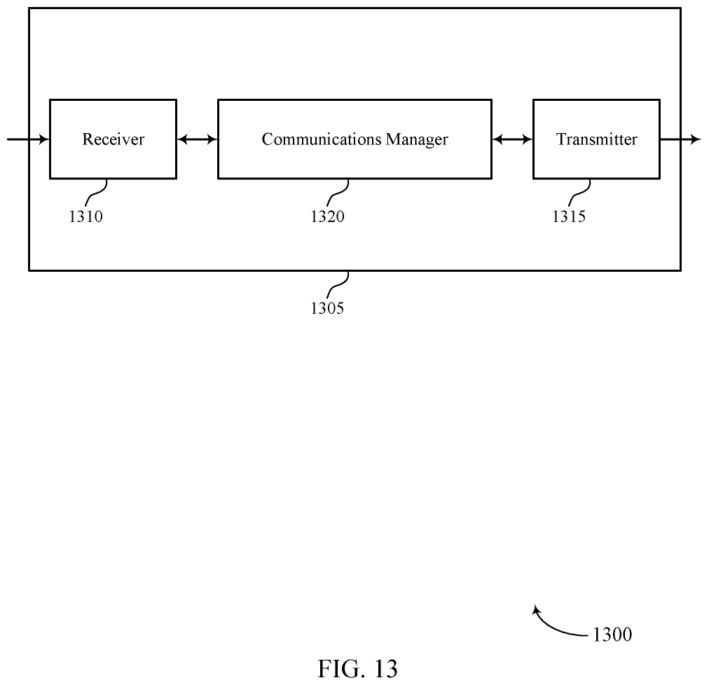

FIG. 13 shows a block diagram 1300 of a device 1305 that supports frequency adjustment for SBFD conflict handling in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, and the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of frequency adjustment for SBFD conflict handling as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor. If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for transmitting, to a UE, a first control message indicating one or more first frequency resources associated with a first signal having a first communication direction between the network entity and the UE, the one or more first frequency resource allocated within a SBFD slot. The communications manager 1320 is capable of, configured to, or operable to support a means for transmitting, to the UE, a second control message indicating one or more second frequency resources associated with a second signal having a second communication direction between the network entity and the UE that is different from the first communication direction, where the one or more second frequency resources are allocated within the SBFD slot and at least partially overlap the one or more first frequency resources in a frequency domain. The communications manager 1320 is capable of, configured to, or operable to support a means for communicating, with the UE, the first signal via one or more third frequency resources, the second signal via the one or more second frequency resources, or both, during the SBFD slot, where the one or more third frequency resources being based on an adjustment procedure for the one or more first frequency resources, and where the adjustment procedure is based on the one or more second frequency resources at least partially overlapping the one or more first frequency resources in the frequency domain.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for improving SBFD communications, thereby improving system efficiency, capacity, and latency.

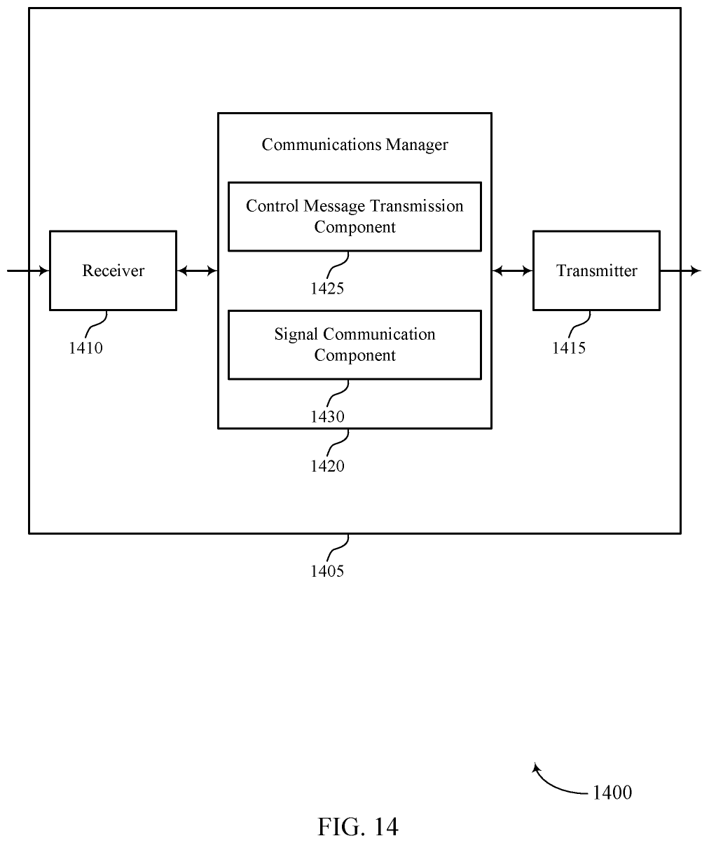

FIG. 14 shows a block diagram 1400 of a device 1405 that supports frequency adjustment for SBFD conflict handling in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, and the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of frequency adjustment for SBFD conflict handling as described herein. For example, the communications manager 1420 may include a control message transmission component 1425 a signal communication component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The control message transmission component 1425 is capable of, configured to, or operable to support a means for transmitting, to a UE, a first control message indicating one or more first frequency resources associated with a first signal having a first communication direction between the network entity and the UE, the one or more first frequency resource allocated within a SBFD slot. The control message transmission component 1425 is capable of, configured to, or operable to support a means for transmitting, to the UE, a second control message indicating one or more second frequency resources associated with a second signal having a second communication direction between the network entity and the UE that is different from the first communication direction, where the one or more second frequency resources are allocated within the SBFD slot and at least partially overlap the one or more first frequency resources in a frequency domain. The signal communication component 1430 is capable of, configured to, or operable to support a means for communicating, with the UE, the first signal via one or more third frequency resources, the second signal via the one or more second frequency resources, or both, during the SBFD slot, where the one or more third frequency resources are based on an adjustment procedure for the one or more first frequency resources, and where the adjustment procedure is based on the one or more second frequency resources at least partially overlapping the one or more first frequency resources in the frequency domain.

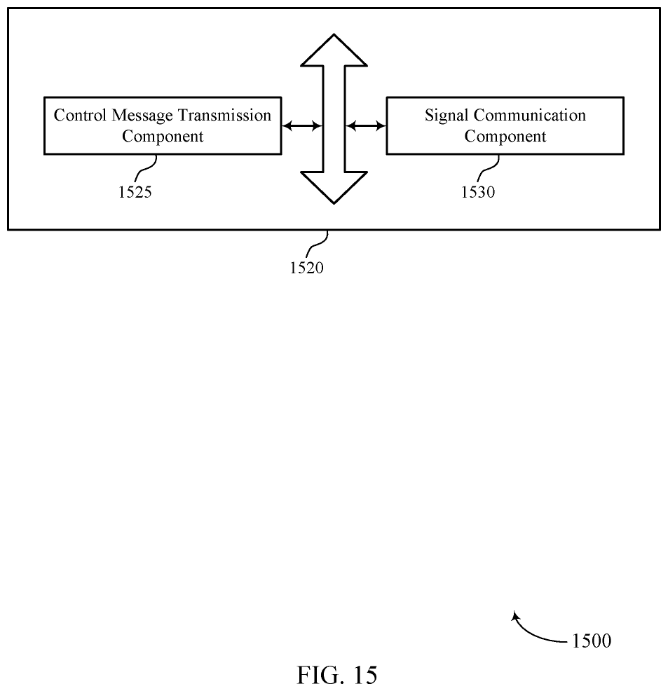

FIG. 15 shows a block diagram 1500 of a communications manager 1520 that supports frequency adjustment for SBFD conflict handling in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of frequency adjustment for SBFD conflict handling as described herein. For example, the communications manager 1520 may include a control message transmission component 1525 a signal communication component 1530, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The control message transmission component 1525 is capable of, configured to, or operable to support a means for transmitting, to a UE, a first control message indicating one or more first frequency resources associated with a first signal having a first communication direction between the network entity and the UE, the one or more first frequency resource allocated within a SBFD slot. In some examples, the control message transmission component 1525 is capable of, configured to, or operable to support a means for transmitting, to the UE, a second control message indicating one or more second frequency resources associated with a second signal having a second communication direction between the network entity and the UE that is different from the first communication direction, where the one or more second frequency resources are allocated within the SBFD slot and at least partially overlap the one or more first frequency resources in a frequency domain. The signal communication component 1530 is capable of, configured to, or operable to support a means for communicating, with the UE, the first signal via one or more third frequency resources, the second signal via the one or more second frequency resources, or both, during the SBFD slot, where the one or more third frequency resources are based on an adjustment procedure for the one or more first frequency resources, and where the adjustment procedure is based on the one or more second frequency resources at least partially overlapping the one or more first frequency resources in the frequency domain.

In some examples, the one or more first frequency resources and the one or more third frequency resources are allocated within a first sub-band of the SBFD slot configured for the first communication direction; and the one or more second frequency resources are allocated at least partially within the first sub-band or at least partially within a guard band between the first sub-band and a second sub-band of the SBFD slot configured for the second communication direction.

In some examples, the one or more third frequency resources are selected from the one or more first frequency resources. In some examples, a resource separation between the one or more third frequency resources and the one or more second frequency resources in the frequency domain satisfies a threshold quantity of RBs corresponding to a size of the guard band.

In some examples, the one or more first frequency resources are shifted within the first sub-band to obtain the one or more third frequency resources. In some examples, the one or more first frequency resources and the one or more third frequency resources include a same quantity of RBs.

In some examples, the one or more second frequency resources are allocated within a first sub-band of the SBFD slot configured for the second communication direction; and the one or more first frequency resources are allocated at least partially within the first sub-band.

In some examples, the control message transmission component 1525 is capable of, configured to, or operable to support a means for transmitting, to the UE, a third control message indicating a type of adjustment procedure for the one or more first frequency resources, where communicating the first signal via the one or more third frequency resources is based on transmitting the third control message.

In some examples, the control message transmission component 1525 is capable of, configured to, or operable to support a means for transmitting a control message that dynamically schedules the first signal or activates the first signal for semi-persistent scheduling, where the third control message is specific to the UE, associated with a group of UEs including the UE, or broadcast to each UE of a cell including the UE.

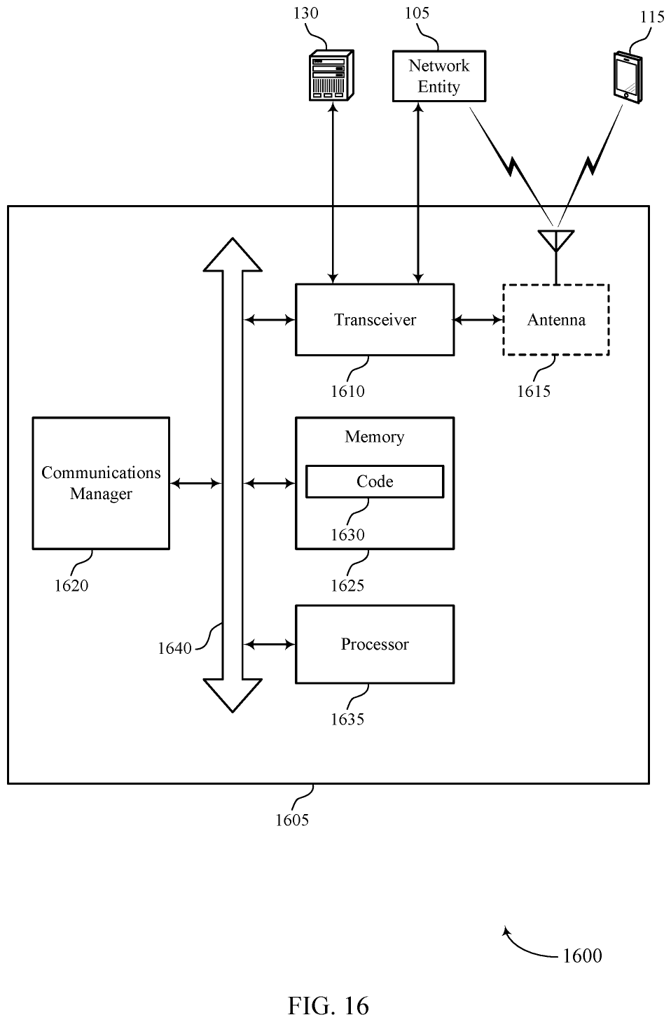

FIG. 16 shows a diagram of a system 1600 including a device 1605 that supports frequency adjustment for SBFD conflict handling in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., a communication link 125, a backhaul communication link 120, a midhaul communication link 162, a fronthaul communication link 168).

The at least one memory 1625 may include RAM, ROM, or any combination thereof. The at least one memory 1625 may store computer-readable, computer-executable code 1630 including instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may contain, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting frequency adjustment for SBFD conflict handling). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625). In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. As such, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for transmitting, to a UE, a first control message indicating one or more first frequency resources associated with a first signal having a first communication direction between the network entity and the UE, the one or more first frequency resource allocated within a SBFD slot. The communications manager 1620 is capable of, configured to, or operable to support a means for transmitting, to the UE, a second control message indicating one or more second frequency resources associated with a second signal having a second communication direction between the network entity and the UE that is different from the first communication direction, where the one or more second frequency resources are allocated within the SBFD slot and at least partially overlap the one or more first frequency resources in a frequency domain. The communications manager 1620 is capable of, configured to, or operable to support a means for communicating, with the UE, the first signal via one or more third frequency resources, the second signal via the one or more second frequency resources, or both, during the SBFD slot, where the one or more third frequency resources being based on an adjustment procedure for the one or more first frequency resources, and where the adjustment procedure is based on the one or more second frequency resources at least partially overlapping the one or more first frequency resources in the frequency domain.

By including or configuring the communications manager 1620 in accordance with examples as described herein, the device 1605 may support techniques for improving SBFD communications, thereby improving system efficiency, capacity, and latency.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of frequency adjustment for SBFD conflict handling as described herein, or the at least one processor 1635 and the at least one memory 1625 may be otherwise configured to, individually or collectively, perform or support such operations.

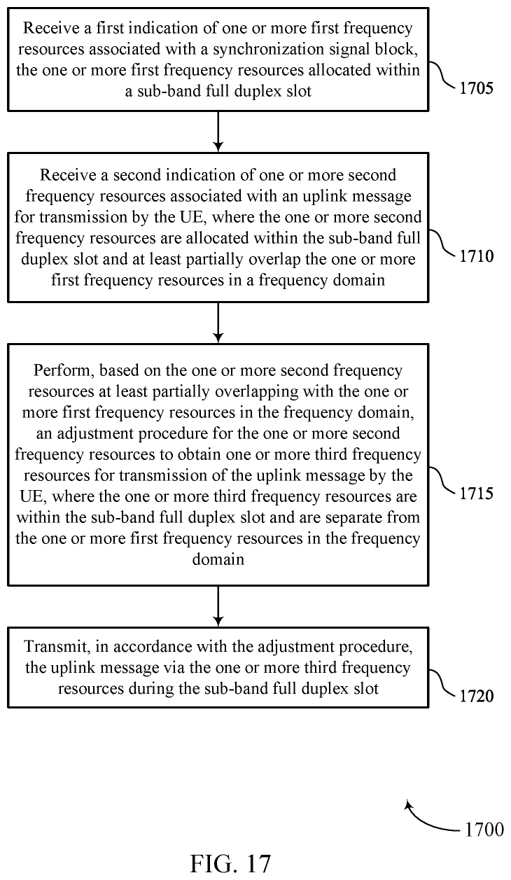

FIG. 17 shows a flowchart illustrating a method 1700 that supports frequency adjustment for SBFD conflict handling in accordance with aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving a first indication of one or more first frequency resources associated with a SSB, the one or more first frequency resources allocated within a SBFD slot. The operations of block 1705 may be performed in accordance with examples as disclosed herein. In some examples, aspects of the operations of 1705 may be performed by a resource indication reception component 1125 as described with reference to FIG. 11.

At 1710, the method may include receiving a second indication of one or more second frequency resources associated with an uplink message for transmission by the UE, where the one or more second frequency resources are allocated within the SBFD slot and at least partially overlap the one or more first frequency resources in a frequency domain. The operations of block 1710 may be performed in accordance with examples as disclosed herein. In some examples, aspects of the operations of 1710 may be performed by a resource indication reception component 1125 as described with reference to FIG. 11.

At 1715, the method may include performing, based on the one or more second frequency resources at least partially overlapping with the one or more first frequency resources in the frequency domain, an adjustment procedure for the one or more second frequency resources to obtain one or more third frequency resources for transmission of the uplink message by the UE, where the one or more third frequency resources are within the SBFD slot and are separate from the one or more first frequency resources in the frequency domain. The operations of block 1715 may be performed in accordance with examples as disclosed herein. In some examples, aspects of the operations of 1715 may be performed by a frequency adjustment component 1130 as described with reference to FIG. 11.

At 1720, the method may include transmitting, in accordance with the adjustment procedure, the uplink message via the one or more third frequency resources during the SBFD slot. The operations of block 1720 may be performed in accordance with examples as disclosed herein. In some examples, aspects of the operations of 1720 may be performed by a message transmission component 1135 as described with reference to FIG. 11.

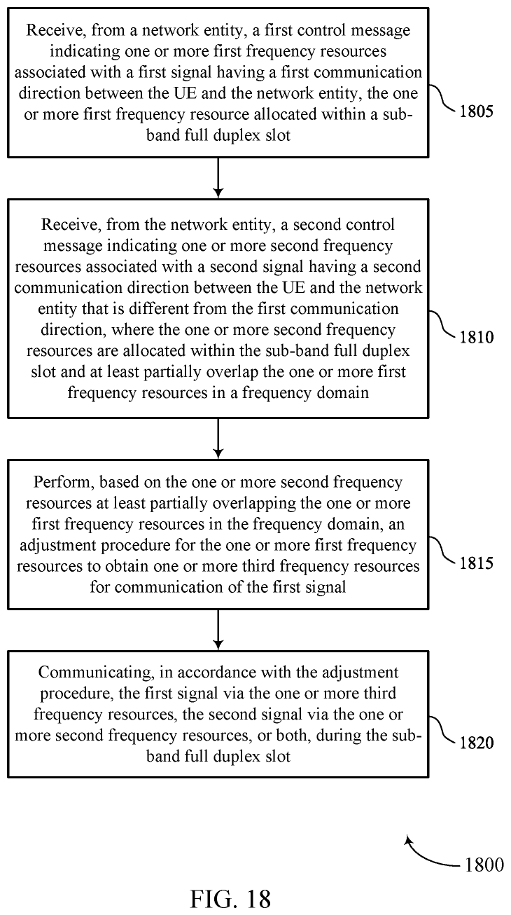

FIG. 18 shows a flowchart illustrating a method 1800 that supports frequency adjustment for SBFD conflict handling in accordance with aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving, from a network entity, a first control message indicating one or more first frequency resources associated with a first signal having a first communication direction between the UE and the network entity, the one or more first frequency resource allocated within a SBFD slot. The operations of block 1805 may be performed in accordance with examples as disclosed herein. In some examples, aspects of the operations of 1805 may be performed by a resource indication reception component 1125 as described with reference to FIG. 11.

At 1810, the method may include receiving, from the network entity, a second control message indicating one or more second frequency resources associated with a second signal having a second communication direction between the UE and the network entity that is different from the first communication direction, where the one or more second frequency resources are allocated within the SBFD slot and at least partially overlap the one or more first frequency resources in a frequency domain. The operations of block 1810 may be performed in accordance with examples as disclosed herein. In some examples, aspects of the operations of 1810 may be performed by a resource indication reception component 1125 as described with reference to FIG. 11.

At 1815, the method may include performing, based on the one or more second frequency resources at least partially overlapping the one or more first frequency resources in the frequency domain, an adjustment procedure for the one or more first frequency resources to obtain one or more third frequency resources for communication of the first signal. The operations of block 1815 may be performed in accordance with examples as disclosed herein. In some examples, aspects of the operations of 1815 may be performed by a frequency adjustment component 1130 as described with reference to FIG. 11.

At 1820, the method may include communicating, in accordance with the adjustment procedure, the first signal via the one or more third frequency resources, the second signal via the one or more second frequency resources, or both, during the SBFD slot. The operations of block 1820 may be performed in accordance with examples as disclosed herein. In some examples, aspects of the operations of 1820 may be performed by a signal communication component 1140 as described with reference to FIG. 11.

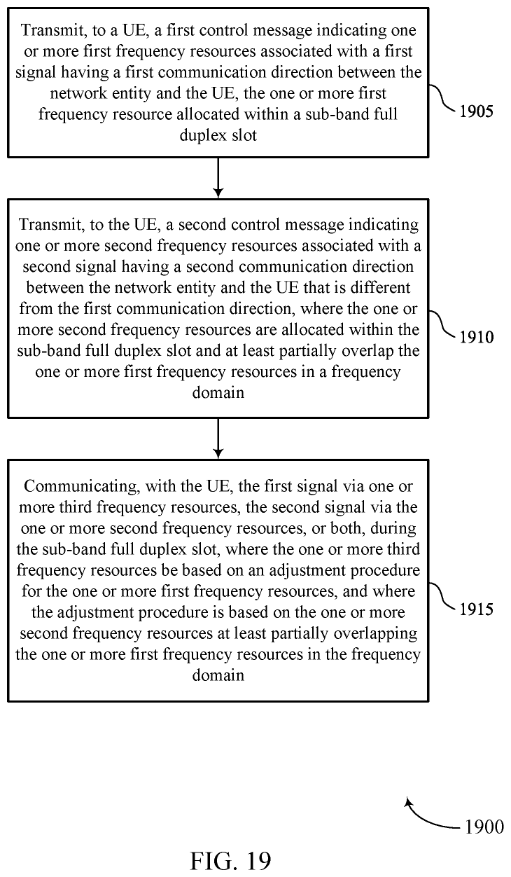

FIG. 19 shows a flowchart illustrating a method 1900 that supports frequency adjustment for SBFD conflict handling in accordance with aspects of the present disclosure. The operations of the method 1900 may be implemented by a network entity or its components as described herein. For example, the operations of the method 1900 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a UE, a first control message indicating one or more first frequency resources associated with a first signal having a first communication direction between the network entity and the UE, the one or more first frequency resource allocated within a SBFD slot. The operations of block 1905 may be performed in accordance with examples as disclosed herein. In some examples, aspects of the operations of 1905 may be performed by a control message transmission component 1525 as described with reference to FIG. 15.

At 1910, the method may include transmitting, to the UE, a second control message indicating one or more second frequency resources associated with a second signal having a second communication direction between the network entity and the UE that is different from the first communication direction, where the one or more second frequency resources are allocated within the SBFD slot and at least partially overlap the one or more first frequency resources in a frequency domain. The operations of block 1910 may be performed in accordance with examples as disclosed herein. In some examples, aspects of the operations of 1910 may be performed by a control message transmission component 1525 as described with reference to FIG. 15.

At 1915, the method may include communicating, with the UE, the first signal via one or more third frequency resources, the second signal via the one or more second frequency resources, or both, during the SBFD slot, where the one or more third frequency resources are based on an adjustment procedure for the one or more first frequency resources, and where the adjustment procedure is based on the one or more second frequency resources at least partially overlapping the one or more first frequency resources in the frequency domain. The operations of block 1915 may be performed in accordance with examples as disclosed herein. In some examples, aspects of the operations of 1915 may be performed by a signal communication component 1530 as described with reference to FIG. 15.

The following provides an overview of aspects of the present disclosure:

Aspect 1: A method for wireless communications by a UE, comprising: receiving a first indication of one or more first frequency resources associated with a SSB, the one or more first frequency resources allocated within a SBFD slot; receiving a second indication of one or more second frequency resources associated with an uplink message for transmission by the UE, wherein the one or more second frequency resources are allocated within the SBFD slot and at least partially overlap the one or more first frequency resources in a frequency domain; performing, based at least in part on the one or more second frequency resources at least partially overlapping with the one or more first frequency resources in the frequency domain, an adjustment procedure for the one or more second frequency resources to obtain one or more third frequency resources for transmission of the uplink message by the UE, wherein the one or more third frequency resources are within the SBFD slot and are separate from the one or more first frequency resources in the frequency domain; and transmitting, in accordance with the adjustment procedure, the uplink message via the one or more third frequency resources during the SBFD slot.

Aspect 2: The method of aspect 1, wherein the one or more second frequency resources and the one or more third frequency resources are allocated within an uplink sub-band of the SBFD slot; and the one or more first frequency resources are allocated at least partially within the uplink sub-band or at least partially within a guard band between the uplink sub-band and a downlink sub-band of the SBFD slot.

Aspect 3: The method of aspect 2, wherein performing the adjustment procedure comprises: selecting the one or more third frequency resources from the one or more second frequency resources, wherein a resource separation between the one or more third frequency resources and the one or more first frequency resources in the frequency domain satisfies a threshold quantity of RBs corresponding to a size of the guard band.

Aspect 4: The method of aspect 3, wherein selecting the one or more third frequency resources comprises: selecting the one or more third frequency resources from a portion of the one or more second frequency resources that does not overlap the one or more first frequency resources.

Aspect 5: The method of any of aspects 3 through 4, wherein transmitting the uplink message comprises: applying uplink rate matching to the one or more third resources based at least in part on selecting the one or more third resources; and transmitting the uplink message in accordance with a data rate that is based at least in part on applying the uplink rate matching.

Aspect 6: The method of aspect 2, wherein performing the frequency adjustment procedure comprises: shifting, within the uplink sub-band, the one or more second frequency resources to obtain the one or more third frequency resources, wherein the one or more second frequency resources and the one or more third frequency resources comprise a same quantity of RBs.

Aspect 7: The method of any of aspects 1 through 6, further comprising: transmitting a capability report indicating a capability of the UE to perform uplink rate matching.

Aspect 8: The method of any of aspects 1 through 7, further comprising: selecting a type of the adjustment procedure from a plurality of types of adjustment procedures in accordance with one or more rules that are based at least in part on the one or more second frequency resources at least partially overlapping the one or more first frequency resources in the frequency domain.

Aspect 9: The method of any of aspects 1 through 8, further comprising: receiving a control message indicating a type of the adjustment procedure, wherein the adjustment procedure is performed in accordance with the type.

Aspect 10: The method of any of aspects 1 through 9, further comprising: receiving a control signal that dynamically schedules the uplink message or activates the uplink message for semi-persistent scheduling, wherein the control signal is specific to the UE, associated with a group of UEs comprising the UE, or broadcast to each UE of a cell comprising the UE.

Aspect 11: A method for wireless communications by a UE, comprising: receiving, from a network entity, a first control message indicating one or more first frequency resources associated with a first signal having a first communication direction between the UE and the network entity, the one or more first frequency resource allocated within a SBFD slot; receiving, from the network entity, a second control message indicating one or more second frequency resources associated with a second signal having a second communication direction between the UE and the network entity that is different from the first communication direction, wherein the one or more second frequency resources are allocated within the SBFD slot and at least partially overlap the one or more first frequency resources in a frequency domain; performing, based at least in part on the one or more second frequency resources at least partially overlapping the one or more first frequency resources in the frequency domain, an adjustment procedure for the one or more first frequency resources to obtain one or more third frequency resources for communication of the first signal; and communicating, in accordance with the adjustment procedure, the first signal via the one or more third frequency resources, the second signal via the one or more second frequency resources, or both, during the SBFD slot.

Aspect 12: The method of aspect 11, wherein the one or more first frequency resources and the one or more third frequency resources are allocated within a first sub-band of the SBFD slot configured for the first communication direction; and the one or more second frequency resources are allocated at least partially within the first sub-band or at least partially within a guard band between the first sub-band and a second sub-band of the SBFD slot configured for the second communication direction.

Aspect 13: The method of aspect 12, wherein performing the adjustment procedure comprises: selecting the one or more third frequency resources from the one or more first frequency resources, wherein a resource separation between the one or more third frequency resources and the one or more second frequency resources in the frequency domain satisfies a threshold quantity of RBs corresponding to a size of the guard band.

Aspect 14: The method of aspect 13, wherein selecting the one or more third frequency resource comprises: selecting the one or more third frequency resource from a portion of the one or more first frequency resources that does not overlap the one or more second frequency resources.

Aspect 15: The method of any of aspects 13 through 14, wherein communicating the first signal comprises: applying the rate matching to the one or more third resources based at least in part on selecting the one or more third resources; and communicating the first signal in accordance with a data rate that is based at least in part on applying the rate matching.

Aspect 16: The method of aspect 12, wherein performing the adjustment procedure comprises: shifting, within the first sub-band, the one or more first frequency resources to obtain the one or more third frequency resources, wherein the one or more first frequency resources and the one or more third frequency resources comprise a same quantity of RBs.

Aspect 17: The method of any of aspects 11 through 16, wherein the one or more second frequency resources are allocated within a first sub-band of the SBFD slot configured for the second communication direction; and the one or more first frequency resources are allocated at least partially within the first sub-band, wherein performing the adjustment procedure is based at least in part on the one or more first frequency resource being allocated at least partially within the first sub-band.

Aspect 18: The method of any of aspects 11 through 17, further comprising: selecting a type of the adjustment procedure from a plurality of types of adjustment procedures in accordance with one or more rules that are based at least in part on the one or more second frequency resources at least partially overlapping the one or more first frequency resources in the frequency domain.

Aspect 19: The method of any of aspects 11 through 18, further comprising: receiving a third control message indicating a type of the adjustment procedure, wherein the adjustment procedure is performed in accordance with the type.

Aspect 20: The method of any of aspects 11 through 19, further comprising: receiving a third control message that dynamically schedules the first signal or activates the first signal for semi-persistent scheduling, wherein the third control message is specific to the UE, associated with a group of UEs comprising the UE, or broadcast to each UE of a cell comprising the UE.

Aspect 21: The method of any of aspects 11 through 20, wherein the first signal is dynamically scheduled and the second signal is periodically scheduled or semi-persistently scheduled; the first signal is periodically scheduled or semi-persistently scheduled and the second signal is dynamically scheduled; or the first signal is periodically scheduled or semi-persistently scheduled and the second signal is periodically scheduled or semi-persistently scheduled.

Aspect 22: A method for wireless communications by a network entity, comprising: transmitting, to a UE, a first control message indicating one or more first frequency resources associated with a first signal having a first communication direction between the network entity and the UE, the one or more first frequency resource allocated within a SBFD slot; transmitting, to the UE, a second control message indicating one or more second frequency resources associated with a second signal having a second communication direction between the network entity and the UE that is different from the first communication direction, wherein the one or more second frequency resources are allocated within the SBFD slot and at least partially overlap the one or more first frequency resources in a frequency domain; communicating, with the UE, the first signal via one or more third frequency resources, the second signal via the one or more second frequency resources, or both, during the SBFD slot, wherein the one or more third frequency resources are based at least in part on an adjustment procedure for the one or more first frequency resources, and wherein the adjustment procedure is based at least in part on the one or more second frequency resources at least partially overlapping the one or more first frequency resources in the frequency domain.

Aspect 23: The method of aspect 22, wherein the one or more first frequency resources and the one or more third frequency resources are allocated within a first sub-band of the SBFD slot configured for the first communication direction; and the one or more second frequency resources are allocated at least partially within the first sub-band or at least partially within a guard band between the first sub-band and a second sub-band of the SBFD slot configured for the second communication direction.

Aspect 24: The method of aspect 23, wherein the one or more third frequency resources are selected from the one or more first frequency resources, a resource separation between the one or more third frequency resources and the one or more second frequency resources in the frequency domain satisfies a threshold quantity of RBs corresponding to a size of the guard band.

Aspect 25: The method of aspect 23, wherein the one or more first frequency resources are shifted within the first sub-band to obtain the one or more third frequency resources, the one or more first frequency resources and the one or more third frequency resources comprise a same quantity of RBs.

Aspect 26: The method of any of aspects 22 through 25, wherein the one or more second frequency resources are allocated within a first sub-band of the SBFD slot configured for the second communication direction; and the one or more first frequency resources are allocated at least partially within the first sub-band.

Aspect 27: The method of any of aspects 22 through 26, further comprising: transmitting, to the UE, a third control message indicating a type of adjustment procedure for the one or more first frequency resources, wherein communicating the first signal via the one or more third frequency resources is based at least in part on transmitting the third control message.

Aspect 28: The method of any of aspects 22 through 27, further comprising: transmitting a control message that dynamically schedules the first signal or activates the first signal for semi-persistent scheduling, wherein the third control message is specific to the UE, associated with a group of UEs comprising the UE, or broadcast to each UE of a cell comprising the UE.

Aspect 29: A UE for wireless communications, comprising one or more memories storing processor-executable code, and one or more processors coupled with the one or more memories and individually or collectively operable to execute the code to cause the UE to perform a method of any of aspects 1 through 10.

Aspect 30: A UE for wireless communications, comprising at least one means for performing a method of any of aspects 1 through 10.

Aspect 31: A non-transitory computer-readable medium storing code for wireless communications, the code comprising instructions executable by a processor to perform a method of any of aspects 1 through 10.

Aspect 32: A UE for wireless communications, comprising one or more memories storing processor-executable code, and one or more processors coupled with the one or more memories and individually or collectively operable to execute the code to cause the UE to perform a method of any of aspects 11 through 21.

Aspect 33: A UE for wireless communications, comprising at least one means for performing a method of any of aspects 11 through 21.

Aspect 34: A non-transitory computer-readable medium storing code for wireless communications, the code comprising instructions executable by a processor to perform a method of any of aspects 11 through 21.

Aspect 35: A network entity for wireless communications, comprising one or more memories storing processor-executable code, and one or more processors coupled with the one or more memories and individually or collectively operable to execute the code to cause the network entity to perform a method of any of aspects 22 through 28.

Aspect 36: A network entity for wireless communications, comprising at least one means for performing a method of any of aspects 22 through 28.

Aspect 37: A non-transitory computer-readable medium storing code for wireless communications, the code comprising instructions executable by a processor to perform a method of any of aspects 22 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first indication of one or more first frequency resources associated with a synchronization signal block, the one or more first frequency resources allocated within a sub-band full duplex slot;
receive a second indication of one or more second frequency resources associated with an uplink message for transmission by the UE, wherein the one or more second frequency resources are allocated within the sub-band full duplex slot and at least partially overlap the one or more first frequency resources in a frequency domain;
perform, based at least in part on the one or more second frequency resources at least partially overlapping with the one or more first frequency resources in the frequency domain, an adjustment procedure for the one or more second frequency resources to obtain one or more third frequency resources for transmission of the uplink message by the UE, wherein the one or more third frequency resources are within the sub-band full duplex slot and are separate from the one or more first frequency resources in the frequency domain; and
transmit, in accordance with the adjustment procedure, the uplink message via the one or more third frequency resources during the sub-band full duplex slot.

2. The UE of claim 1, wherein:
the one or more second frequency resources and the one or more third frequency resources are allocated within an uplink sub-band of the sub-band full duplex slot; and
the one or more first frequency resources are allocated at least partially within the uplink sub-band or at least partially within a guard band between the uplink sub-band and a downlink sub-band of the sub-band full duplex slot.

3. The UE of claim 2, wherein, to perform the adjustment procedure, the one or more processors are individually or collectively operable to execute the code to cause the UE to:
select the one or more third frequency resources from the one or more second frequency resources, wherein a resource separation between the one or more third frequency resources and the one or more first frequency resources in the frequency domain satisfies a threshold quantity of resource blocks corresponding to a size of the guard band.

4. The UE of claim 3, wherein, to select the one or more third frequency resources, the one or more processors are individually or collectively operable to execute the code to cause the UE to:
select the one or more third frequency resources from a portion of the one or more second frequency resources that does not overlap the one or more first frequency resources.

5. The UE of claim 3, wherein, to transmit the uplink message, the one or more processors are individually or collectively operable to execute the code to cause the UE to:
apply uplink rate matching to the one or more third frequency resources based at least in part on selecting the one or more third frequency resources; and
transmit the uplink message in accordance with a data rate that is based at least in part on applying the uplink rate matching.

6. The UE of claim 2, wherein, to perform the adjustment procedure, the one or more processors are individually or collectively operable to execute the code to cause the UE to:
shift, within the uplink sub-band, the one or more second frequency resources to obtain the one or more third frequency resources, wherein the one or more second frequency resources and the one or more third frequency resources comprise a same quantity of resource blocks.

7. The UE of claim 1, wherein the one or more processors are individually or collectively further operable to execute the code to cause the UE to:
transmit a capability report indicating a capability of the UE to perform uplink rate matching.

8. The UE of claim 1, wherein the one or more processors are individually or collectively further operable to execute the code to cause the UE to:
select a type of the adjustment procedure from a plurality of types of adjustment procedures in accordance with one or more rules that are based at least in part on the one or more second frequency resources at least partially overlapping the one or more first frequency resources in the frequency domain.

9. The UE of claim 1, wherein the one or more processors are individually or collectively further operable to execute the code to cause the UE to:
receive a control message indicating a type of the adjustment procedure, wherein the adjustment procedure is performed in accordance with the type.

10. The UE of claim 1, wherein the one or more processors are individually or collectively further operable to execute the code to cause the UE to:
receive a control signal that dynamically schedules the uplink message or activates the uplink message for semi-persistent scheduling, wherein the control signal is specific to the UE, associated with a group of UEs comprising the UE, or broadcast to each UE of a cell comprising the UE.

11. A user equipment (UE), comprising:
one or more memories storing processor-executable code; and
one or more processors coupled with the one or more memories and individually or collectively operable to execute the code to cause the UE to:
receive, from a network entity, a first control message indicating one or more first frequency resources associated with a first signal having a first communication direction between the UE and the network entity, the one or more first frequency resources allocated within a sub-band full duplex slot;
receive, from the network entity, a second control message indicating one or more second frequency resources associated with a second signal having a second communication direction between the UE and the network entity that is different from the first communication direction, wherein the one or more second frequency resources are allocated within the sub-band full duplex slot and at least partially overlap the one or more first frequency resources in a frequency domain;
perform, based at least in part on the one or more second frequency resources at least partially overlapping the one or more first frequency resources in the frequency domain, an adjustment procedure for the one or more first frequency resources to obtain one or more third frequency resources for communication of the first signal; and
communicate, in accordance with the adjustment procedure, the first signal via the one or more third frequency resources, the second signal via the one or more second frequency resources, or both, during the sub-band full duplex slot.

12. The UE of claim 11, wherein:
the one or more first frequency resources and the one or more third frequency resources are allocated within a first sub-band of the sub-band full duplex slot configured for the first communication direction; and
the one or more second frequency resources are allocated at least partially within the first sub-band or at least partially within a guard band between the first sub-band and a second sub-band of the sub-band full duplex slot configured for the second communication direction.

13. The UE of claim 12, wherein, to perform the adjustment procedure, the one or more processors are individually or collectively operable to execute the code to cause the UE to:
select the one or more third frequency resources from the one or more first frequency resources, wherein a resource separation between the one or more third frequency resources and the one or more second frequency resources in the frequency domain satisfies a threshold quantity of resource blocks corresponding to a size of the guard band.

14. The UE of claim 13, wherein, to select the one or more third frequency resources, the one or more processors are individually or collectively operable to execute the code to cause the UE to:
select the one or more third frequency resources from a portion of the one or more first frequency resources that does not overlap the one or more second frequency resources.

15. The UE of claim 13, wherein, to communicate the first signal, the one or more processors are individually or collectively operable to execute the code to cause the UE to:
apply rate matching to the one or more third frequency resources based at least in part on selecting the one or more third frequency resources; and
communicate the first signal in accordance with a data rate that is based at least in part on applying the rate matching.

16. The UE of claim 12, wherein, to perform the adjustment procedure, the one or more processors are individually or collectively operable to execute the code to cause the UE to:
shift, within the first sub-band, the one or more first frequency resources to obtain the one or more third frequency resources, wherein the one or more first frequency resources and the one or more third frequency resources comprise a same quantity of resource blocks.

17. The UE of claim 11, wherein:
the one or more second frequency resources are allocated within a first sub-band of the sub-band full duplex slot configured for the second communication direction; and
the one or more first frequency resources are allocated at least partially within the first sub-band, wherein performing the adjustment procedure is based at least in part on the one or more first frequency resources being allocated at least partially within the first sub-band.

18. The UE of claim 11, wherein the one or more processors are individually or collectively further operable to execute the code to cause the UE to:
select a type of the adjustment procedure from a plurality of types of adjustment procedures in accordance with one or more rules that are based at least in part on the one or more second frequency resources at least partially overlapping the one or more first frequency resources in the frequency domain.

19. The UE of claim 11, wherein the one or more processors are individually or collectively further operable to execute the code to cause the UE to:
receive a third control message indicating a type of the adjustment procedure, wherein the adjustment procedure is performed in accordance with the type.

20. The UE of claim 11, wherein the one or more processors are individually or collectively further operable to execute the code to cause the UE to:
receive a third control message that dynamically schedules the first signal or activates the first signal for semi-persistent scheduling, wherein the third control message is specific to the UE, associated with a group of UEs comprising the UE, or broadcast to each UE of a cell comprising the UE.

21. The UE of claim 11, wherein:
the first signal is dynamically scheduled and the second signal is periodically scheduled or semi-persistently scheduled;
the first signal is periodically scheduled or semi-persistently scheduled and the second signal is dynamically scheduled; or
the first signal is periodically scheduled or semi-persistently scheduled and the second signal is periodically scheduled or semi-persistently scheduled.

22. A network entity, comprising:
one or more memories storing processor-executable code; and
one or more processors coupled with the one or more memories and individually or collectively operable to execute the code to cause the network entity to:
transmit, to a user equipment (UE), a first control message indicating one or more first frequency resources associated with a first signal having a first communication direction between the network entity and the UE, the one or more first frequency resources allocated within a sub-band full duplex slot;
transmit, to the UE, a second control message indicating one or more second frequency resources associated with a second signal having a second communication direction between the network entity and the UE that is different from the first communication direction, wherein the one or more second frequency resources are allocated within the sub-band full duplex slot and at least partially overlap the one or more first frequency resources in a frequency domain; and
communicate, with the UE, the first signal via one or more third frequency resources, the second signal via the one or more second frequency resources, or both, during the sub-band full duplex slot, wherein the one or more third frequency resources be based at least in part on an adjustment procedure for the one or more first frequency resources, and wherein the adjustment procedure is based at least in part on the one or more second frequency resources at least partially overlapping the one or more first frequency resources in the frequency domain.

23. The network entity of claim 22, wherein:
the one or more first frequency resources and the one or more third frequency resources are allocated within a first sub-band of the sub-band full duplex slot configured for the first communication direction; and
the one or more second frequency resources are allocated at least partially within the first sub-band or at least partially within a guard band between the first sub-band and a second sub-band of the sub-band full duplex slot configured for the second communication direction.

24. The network entity of claim 23, wherein the one or more third frequency resources are selected from the one or more first frequency resources, wherein a resource separation between the one or more third frequency resources and the one or more second frequency resources in the frequency domain satisfies a threshold quantity of resource blocks corresponding to a size of the guard band.

25. The network entity of claim 23, wherein the one or more first frequency resources are shifted within the first sub-band to obtain the one or more third frequency resources, wherein the one or more first frequency resources and the one or more third frequency resources comprise a same quantity of resource blocks.

26. The network entity of claim 22, wherein:
the one or more second frequency resources are allocated within a first sub-band of the sub-band full duplex slot configured for the second communication direction; and
the one or more first frequency resources are allocated at least partially within the first sub-band.

27. The network entity of claim 22, wherein the one or more processors are individually or collectively further operable to execute the code to cause the network entity to:
transmit, to the UE, a third control message indicating a type of adjustment procedure for the one or more first frequency resources, wherein communicating the first signal via the one or more third frequency resources is based at least in part on transmitting the third control message.

28. The network entity of claim 22, wherein the one or more processors are individually or collectively further operable to execute the code to cause the network entity to:
transmit a third control message that dynamically schedules the first signal or activates the first signal for semi-persistent scheduling, wherein the third control message is specific to the UE, associated with a group of UEs comprising the UE, or broadcast to each UE of a cell comprising the UE.

29. A method for wireless communications by a user equipment (UE), comprising:
receiving a first indication of one or more first frequency resources associated with a synchronization signal block, the one or more first frequency resources allocated within a sub-band full duplex slot;
receiving a second indication of one or more second frequency resources associated with an uplink message for transmission by the UE, wherein the one or more second frequency resources are allocated within the sub-band full duplex slot and at least partially overlap the one or more first frequency resources in a frequency domain;
performing, based at least in part on the one or more second frequency resources at least partially overlapping with the one or more first frequency resources in the frequency domain, an adjustment procedure for the one or more second frequency resources to obtain one or more third frequency resources for transmission of the uplink message by the UE, wherein the one or more third frequency resources are within the sub-band full duplex slot and are separate from the one or more first frequency resources in the frequency domain; and
transmitting, in accordance with the adjustment procedure, the uplink message via the one or more third frequency resources during the sub-band full duplex slot.

30. The method of claim 29, wherein:
the one or more second frequency resources and the one or more third frequency resources are allocated within an uplink sub-band of the sub-band full duplex slot; and
the one or more first frequency resources are allocated at least partially within the uplink sub-band or at least partially within a guard band between the uplink sub-band and a downlink sub-band of the sub-band full duplex slot.
